(19) United States
(12) Patent Application Publication
(10) Pub. No.: US 2007/0177688 A1
(43) Pub. Date: Aug. 2, 2007

(54) System and method employing linear dispersion over space, time and frequency

(76) Inventors: Jinsong Wu, Kingston (CA); Steven Blostein, Kingston (CA)

Correspondence Address: SMART & BIGGAR;P.O. BOX 2999, STATION D, 900-55 METCALFE STREET, OTTAWA, ON, K1P5Y6, CA

(21) Appl. No.: 11/604,292

(22) Filed: Nov. 27, 2006

Related U.S. Application Data
(60) Provisional application No. 60/739,418, filed on Nov. 25, 2005.

(51) Int. Cl. H04L 1/02

(52) U.S. Cl. 375/267

(57) ABSTRACT

Systems and methods for performing space time coding are provided. Two vector→matrix encoding operations are performed in sequence to produce a three dimensional result containing a respective symbol for each of a plurality of frequencies, for each of a plurality of transmit durations, and for each of a plurality of transmitter outputs. The two vector→matrix encoding operations may be for encoding in a) time-space dimensions and b) time-frequency dimensions sequentially or vice versa.

### RELATED APPLICATION

This application claims the benefit of prior U.S. provisional application No. 60/739,418 filed Nov. 25, 2005, hereby incorporated by reference in its entirety.

### FIELD OF THE INVENTION

The invention relates to encoding and transmission techniques for use in systems transmitting over multiple frequencies and multiple antennas.

### BACKGROUND OF THE INVENTION

Recently, multiple transmit and receive antennas (MIMO) have attracted considerable attention to accommodate broadband wireless communications services. In frequency non-selective fading channels, diversity is available only in space and time domains. The related coding approaches are termed space-time codes (STC) [1]. However, high-data-rate wireless communications often experience wideband frequency-selective fading. In frequency-selective channels, there is additional frequency diversity available due to multipath fading.

Multicarrier modulation, especially orthogonal frequency division multiplexing (OFDM), mitigates frequency selectivity by transforming a wideband multipath channel into multiple parallel narrowband flat fading channels, enabling simple equalization. To obtain frequency diversity in OFDM transmission, space frequency coding (SFC) [2] may be employed, which encodes a source data stream over multiple transmit antennas and OFDM tones. In SFC, codewords lie within one OFDM block period and cannot exploit time diversity over multiple OFDM blocks. Recently, coding over three dimensions—space, time and frequency, or STFC, is being investigated. Most existing block-based STFC designs assume constant MIMO channel coefficients over one STFC codeword (comprising multiple OFDM blocks), but may vary over different STFC codewords. In general, existing STFCs are not high-rate codes. For example, in [3], Liu and Giannakis propose a STFC based on a combination of orthogonal space time block codes [4], [5] and linear constellation preceding [6]; Gong and Letaief introduce the use of trellis-based STFC [7], Luo and Wu consider the design of bit-interleaved space-time-frequency block coding (BI-STFBC) [8], and Su and Liu proposes a symbol coding rate 1/min {N_{T},N_{R}} STFC using Vandermonde matrix as encoding matrix, where N_{T} is the number of transmit antennas [9].

### SUMMARY OF THE INVENTION

According to one broad aspect, the invention provides a method comprising: performing two vector→matrix encoding operations in sequence to produce a three dimensional result containing a respective symbol for each of a plurality of frequencies, for each of a plurality of transmit durations, and for each of a plurality of transmitter outputs.

In some embodiments, the two vector→matrix encoding operations are for encoding in a) time-space dimensions and b) time-frequency dimensions sequentially or vice versa.

In some embodiments, the two vector→matrix encoding operations are for encoding in a) time-space dimensions and b) space-frequency dimensions sequentially or vice versa.

In some embodiments, the two vector→matrix encoding operations are for encoding in a) space-frequency dimensions, and b) space-time dimensions sequentially or vice versa.

In some embodiments, the two vector→matrix encoding operations are for encoding in a) space-frequency, and b) frequency-time dimensions sequentially or vice versa.

In some embodiments, the plurality of frequencies comprise a set of OFDM sub-carrier frequencies.

In some embodiments, the method further comprises: defining a plurality of subsets of an overall set of OFDM sub-carriers; executing said performing for each subset to produce a respective three dimensional result.

In some embodiments, executing comprises: for each subset of the plurality of subsets of OFDM sub-carriers, a) for each of a plurality of antennas, encoding a respective set of input symbols into a respective first matrix with frequency and time dimensions using a respective first vector→matrix code, each first matrix having components relating to each of the sub-carriers in the subset; b) for each sub-carrier of the subset, encoding a set of input symbols consisting of the components in the first matrices relating to the sub-carrier into a respective second matrix with space and time dimensions using a second vector→matrix code; c) transmitting each second matrix on the sub-carrier with rows and columns of the second matrix mapping to space (antennas) and time (transmit durations) or vice versa.

In some embodiments, at least one of the first vector→matrix code and second vector→matrix code is a linear dispersion code.

In some embodiments, the first vector→matrix code and the second vector→matrix code are linear dispersion codes.

In some embodiments, in each first matrix, the components relating to each of the sub-carriers in the subset comprise a respective column or row of the first matrix.

In some embodiments, both the first vector→matrix code has a symbol coding rate ≧0.5 and the second vector→matrix code has a symbol coding rate ≧0.5.

In some embodiments, both the first vector→matrix code has a symbol coding rate of one and the second vector→matrix code has a symbol coding rate of one.

In some embodiments, the method as summarized above in which there are M×N×T dimensions in space, frequency, and time and wherein the first and second vector→matrix codes are selected such that an overall symbol coding rate R is larger than

$$\frac{1}{min \{ M , N , T \}} .$$

In some embodiments, the vector→matrix encoding operations are selected such that outputs of each encoding operation are uncorrelated with each other assuming uncorrelated inputs.

In some embodiments, the method comprises: for each of the plurality of subsets of an overall set of OFDM sub-carriers, a) for each sub-carrier of the subset of sub-carriers, encoding a respective set of input symbols into a respective first matrix with space and time dimensions using a respective first vector→matrix code, each first matrix having components relating to each of a plurality of antennas; b) for each of the plurality of antennas, encoding a respective set of input symbols consisting of the components in the first matrices relating to the antenna into a respective second matrix with frequency and time dimensions using a second vector→matrix code; c) transmitting each second matrix on the antenna with rows and columns of the matrix mapping to frequency (sub-carriers) and time (transmit durations) or vice versa.

According to another broad aspect, the invention provides a method comprising: defining a plurality of subsets of an overall set of OFDM sub-carriers; for each subset of the plurality of subsets of OFDM sub-carriers: performing a linear dispersion encoding operation upon a plurality of input symbols to produce a two dimensional matrix output; partitioning the two dimensional matrix into a plurality of matrices, the plurality of matrices consisting of a respective matrix for each of a plurality of transmit antennas; transmitting each matrix on the respective antenna by mapping rows and columns to sub-carrier frequencies and transmit symbol durations or vice versa.

According to another broad aspect, the invention provides a method comprising: performing a linear dispersion encoding operation upon a plurality of input symbols to produce a two dimensional matrix output; partitioning the two dimensional matrix into a plurality of two dimensional matrix partitions; transmitting the partitions by executing one of: transmitting each matrix partition during a respective transmit duration in which case the matrix partition maps to multiple frequencies and multiple transmitter outputs; and transmitting each matrix partition on a respective frequency in which case the matrix partition maps to multiple transmit durations and multiple transmitter outputs; transmitting each matrix partition on a respective transmitter output in which case the matrix partition maps to multiple frequencies and multiple transmit durations.

In some embodiments, the method further comprises transmitting each transmitter output on a respective antenna.

In some embodiments, the codes are selected to have full diversity under the condition of single symbol errors in the channel.

In some embodiments, the codes are selected such that method achieves all an capacity available in an STF channel.

In some embodiments, the subsets of OFDM sub-carriers have variable size.

In some embodiments, a transmitter is adapted to implement the method as summarized above.

In some embodiments, the transmitter comprises: a plurality of transmit antennas; at least one vector→matrix encoder adapted to execute vector→matrix encoding operations; a multi-carrier modulator for producing outputs on multiple frequencies.

In some embodiments, the multi-carrier modulator comprises an IFFT function.

According to another broad aspect, the invention provides a method comprising: receiving a three dimensional signal containing a respective symbol for each of a plurality of frequencies, for each of a plurality of transmit durations, and for each of a plurality of transmitter outputs; performing two matrix→vector decoding operations in sequence to recover a set of transmitted symbols.

In some embodiments, at least one of the matrix→vector decoding operations is an LDC decoding operation.

In some embodiments, the two matrix→vector decoding operations are LDC decoding operations.

In some embodiments, the two vector→matrix encoding operations are for encoding in a) time-space dimensions and b) time-frequency dimensions sequentially or vice versa.

In some embodiments, the two vector→matrix decoding operations are for decoding in a) time-space dimensions and b) space-frequency dimensions sequentially or vice versa.

In some embodiments, the two vector→matrix decoding operations are for decoding in a) space-frequency dimensions, and b) space-time dimensions sequentially or vice versa.

In some embodiments, the two vector matrix decoding operations are for decoding in a) space-frequency, and b) frequency-time dimensions sequentially or vice versa.

In some embodiments, the three dimensional signal consists of a OFDM signals transmitted on a set of transmit antennas.

In some embodiments, the method is executed once for each of a plurality of subsets of OFDM sub-carriers.

In some embodiments, a receiver is adapted to implement the method as summarized above.

In some embodiments, a method/transmitter/receiver as summarized above in which LD codes are employed that have block sizes other than a) square and b) having a column size that is a multiple of the row size.

### BRIEF DESCRIPTION OF THE DRAWINGS

FIG. 1 shows a Layered structure of DLD-STFC communications;

FIG. 2 contains plots of BER Performance of MIMO-OFDM vs. DLD-STFC with different sizes of dispersion matrices and two different LDC subcarrier mappings. L=3; CCR=1 OFDM block, NT=NR=2; Nc=32;

FIG. 3 contains plots of BER Performance of DLD-STFC (ES-LDC-SM) under different CCRs, L=3; NT=NR=2; NC=32, NF=8; T=8;

FIG. 4 contains plots of BER Performance of MIMO-LDC-OFDM(ES-LDC-SM) vs. DLD-STFC (ES-LDC-SM) with the same size of NF, L=3; CCR=1 OFDM block, NT=NR=4; NC=32, NF=8; T=8;

FIG. 5 contains plots of BER Performance of LD-STFC(ES-LDC-SM) vs. DLD-STFC(ES-LDC-SM) with different sizes of Nfreq blocks, L=3; CCR=32 OFDM blocks, NT=NR=2; NC=32, T=32;

FIG. 6 contains plots of BER Performance of LD-STFC(ES-LDC-SM) vs DLD-STFC(ES-LDC-SM) with different sizes of STF blocks, L=3; CCR=16 OFDM blocks, NT=NR=2; NC=32;

FIG. 7 contains plots of BER Performance of DLD-STFC(ES-LDC-SM) under spatial transmit channel correlation coefficients ρ, L=3; CCR=1 OFDM block, NT=NR=2; NC=32, NF=8; T=8;

FIG. 8 is a block diagram of an example DLD-STFC encoder;

FIG. 9 is a block diagram of an example DLD-STFC decoder;

FIG. 10 is a block diagram of an example LD-STFC encoder;

FIG. 11 shows a Layered structure of DLD-STFC communications.

FIG. 12 shows the mapping of the output of the DLD-STFC encoder of FIG. 8 in frequency and time;

FIG. 13 shows the mapping of the output of the DLD-STFC encoder of FIG. 8 in space and time;

FIG. 14 is a block layout in which one RS(a,b,c) codeword is mapped to N_{K} DLD-STFC blocks, and NₐRS symbols are mapped into each of N_{G} FT-LDC codewords within each DLD-STFC block, where a=NₐN_{G}N_{K};

FIG. 15 shows a performance comparison of Bit Error Rate (BER) vs. SNR between DLD-STFC Type A and DLD-STFC Type B with and without satisfaction of DLDCC;

FIGS. 16 and 17 show performance comparisons of FEC based STFCs;

FIG. 18 is a block diagram of a ST-CILDC system structure;

FIGS. 19,20,21 contain performance comparisons of code A;

FIG. 22 contains a performance comparison of code B;

FIG. 23 contains a performance comparison of code C; and

FIG. 24 is a block diagram of a LD-CI-STFC system structure.

### DETAILED DESCRIPTION OF THE PREFERRED EMBODIMENTS

New STFC designs are provided that depending upon specific implementation details may realize some of the following advantages: (1) support of arbitrary numbers of transmit antennas, (2) requirement of constant channel coefficients over only a single OFDM block instead of over a whole STFC codeword, (3) provision of up to rate-one coding, (4) compatibility with non-LDC-coded MIMO-OFDM systems and (5) moderate computation complexity.

Preferred embodiments of the STFC designs employ linear dispersion codes (LDC), which were pioneered in [10] for use as space time codes for block flat-fading channels. An LDC possess coding rates of up to one and can support any configuration of transmit and receive antennas. Originally designed based on maximization of the mutual information between transmitted and received signals [10], ergodic capacity and error probability of LDC were later optimized in [11]. Generally, LDC are not orthogonal, although LDC includes orthogonal space time block codes [4], [5] as a subclass. Maximum-likelihood (ML) or sub-optimal sphere decoding (SD) are the primarily chosen LDC decoding methods [10]-[12], and both have high computational complexity.

Two specific examples will now be described. These are two block-based high-rate STFCs coding procedures with rates up to one—one termed double linear dispersion space-time-frequency-coding (DLD-STFC), and the other termed linear dispersion space-time-frequency-coding (LD-STFC). In both of these approaches, an STF block is formed only across a subset of subcarrier indices instead of across all subcarriers.

A challenging issue in DLD-STFC design is to apply 2-D LDC in a 3-D code design. In DLD-STFC, two complete LDC stages of encoding are used, which process all complex symbols within one DLD-STFC codeword space. The diversity order for DLD-STFC is determined by the choices of LDC for the two stages. In LD-STFC, only a single LDC procedure is used for one STF block, and to achieve performance comparable to DLD-STFC, LD-STFC uses larger LDC sizes, and may be of higher complexity. Comparisons are also made to a system using a single LDC procedure applied only across frequency and time for MIMO-OFDM, termed MIMO-LDC-OFDM.

The detailed description is organized follows: after introducing the LDC encoder in matrix form along with MIMO-OFDM system mode, the DLD-STFC, LD-STFC and MIMO-LDC-OFDM systems are described. Diversity properties of STF block based designs, related to DLD-STFC and LD-STFC, are then discussed. The LDC design criteria based on error union bound is analyzed. Finally System performance of DLD-STFC, LD-STFC and MIMO-LDC-OFDM are compared. Following this, a more general discussion of various embodiments will be presented.

The following notation is used: (·)† denotes matrix pseudoinverse, (·)^{T} matrix transpose, (·)^{H} matrix transpose conjugate, E{.} expectation, j is the square root of −1, I_{K} denotes identity matrix with size K×K, 0_{M×N} denotes zero matrix with size M×N. A⊕B denotes Kronecker (tensor) product of matrices A and B, C^{M×N} denotes a complex matrix with dimensions M×N, [A]_{a,b} denotes the (a,b) entry of matrix A, and diag(·) transforms the argument from a vector to a diagonal matrix.

LDC Encoding

Assume that an uncorrelated data source sequence is modulated using complex-valued source data symbols chosen from an arbitrary, e.g. r-PSK or r-QAM, constellation. A T×M LDC matrix codeword, S_{LDC}, is transmitted from M transmit channels, occupies T channel uses and encodes Q source data symbols. Denote the LDC codeword matrix as S_{LDC}εC^{T×M}, and A_{q}εC^{T×M}, B_{q}εC^{T×M}, q=1, . . . ,Q as dispersion matrices.

Define the vec operation on m×n matrix K as
vec(K)=[[K_{.1}]^{T}, [K_{.2}]^{T}, . . . , [K_{.n}]^{T}]^{T} (1)
where K_{.i} is the i-th column of K.

Just as in [13], we consider the case A_{q}=B_{q},q=1, . . . ,Q. The LDC encoding can be expressed in matrix form,
vec(S_{LDC})=G_{LDC}s (2)
where s=[s₁, . . . , s_{Q}]^{T} is the source complex symbol vector, and
G_{LDC}=[vec(A₁) . . . vec(A_{Q})] (3)
is the LDC encoding matrix. To estimate the data symbol vector in (2), we may calculate the Moore-Penrose pseudo-inverse of G_{LDC} offline and store the result.
MIMO-OFDM System Model
System model

Consider a MIMO-OFDM system with N_{T} transmit antennas, N_{R} receive antennas and a OFDM block of N_{C} subcarriers per antenna. The channel between the m-th transmit antenna and n-th receive antenna in the k-th OFDM block experiences frequency-selective, temporally flat Rayleigh fading with channel coefficients h_{m,n}^{(k)}=[h_{m,n(0)}^{(k)}, . . . , h_{m,n(L)}^{(k)}]^{T}, m=1, . . . ,N_{T}, n=1, . . . ,N_{R}, where

L=max {L_{m,n},m=1, . . . ,N_{T}, n=1, . . . ,N_{R}}, L_{m,n} is frequency selective channel order of the path between m-th transmit antenna and n-th receive antenna. We assume constant channel coefficients within one OFDM block but statistically independent among different OFDM blocks.

Denote x_{m,p}^{(k)},p=1, . . . ,N_{C} be the channel symbol transmitted on the p-th subcarrier from m-th transmit antenna during the k-th OFDM block. The channel symbols {x_{m,n}^{(k)}, m=1, . . . N_{T}, p=1, . . . ,N_{C}} are transmitted on N_{C} subcarriers in parallel by N_{T} transmit antennas. In proposed LD-STFC or DLD-STFC system, channel symbol x_{m,p}^{(k)} have been STF coded symbols.

Each receive antenna signal experiences additive complex Gaussian noise. At the transmitter, a cyclic prefix (CP) guard interval is appended to each OFDM block. After CP is removed, the received channel symbol sample y_{n,p}^{(k)} at the n-th receive antenna, is

$${y}_{n , p}^{( k )} = \sqrt{\frac{ρ}{{N}_{T}}} {\sum }_{m = 1}^{{N}_{r}} {H}_{m , n , p}^{( k )} {x}_{m , p}^{( k )} + {v}_{n , p}^{( k )} , \\ n = 1 , … , {N}_{R} , p = 1 , … , {N}_{c} \qquad ( 4 )$$

where H_{mn,p}^{(k)} is the p-th subcarrier channel gain from m-th transmit antenna and n-th receive antenna during the k-th OFDM block,

$${H}_{m , n , p}^{( k )} = {\sum }_{l = o}^{L} {h}_{m , n ( l )}^{( k )} {ⅇ}^{- j ( 2 π / {N}_{c} ) l ( p - 1 )} \qquad ( 5 )$$

or equivalently

$${H}_{m , n , p}^{( k )} = {[ {w}_{p} ]}^{T} {h}_{m , n}^{( k )} \qquad ( 6 )$$

where wₚ=[1,ω^{p-1}, ω^{2(p-1)}, . . . ,ω^{L(p-1)}]^{T}, ω=e^{-j(2π/N}^{_{C}}⁾, and the additive noise is circularly symmetric, zero-mean, complex Gaussian with variance N₀. Assumed additive noise is statistically independent for different p, n, and k. We assume the additive noise to be statistically independent for different p, n, and k. The normalization

$$\sqrt{\frac{ρ}{{N}_{T}}}$$

ensures that the signal-to-noise-ratio (SNR) at each receive antenna ρ is independent of N_{T}.
Matrix Form

Denote the transmitted channel symbol vector of the p-th subcarrier during the k-th OFDM block as

$${x}_{p}^{( k )} = {[ \begin{matrix}{x}_{1 , p}^{( k )} & ⋯ & {x}_{{N}_{T} , p}^{( k )}\end{matrix} ]}^{T} ∈ {C}^{{N}_{T} \times 1} \qquad ( 7 )$$

the corresponding channel gain matrix of the p-th subcarrier during the k-th OFDM block as

$${H}_{p}^{( k )} = [ \begin{matrix}{H}_{1 , 1 , p}^{( k )} & ⋯ & {H}_{{N}_{T} , 1 , p}^{( k )} \\ ⋮ & ⋰ & ⋮ \\ {H}_{1 , {N}_{R} , p}^{( k )} & ⋯ & {H}_{{N}_{T} , {N}_{R} , p}^{( k )}\end{matrix} ] \qquad ( 8 )$$

the corresponding noise vector as

$${v}_{p}^{( k )} = {[ \begin{matrix}{v}_{1 , p}^{( k )} & ⋯ & {v}_{{N}_{R} , p}^{( k )}\end{matrix} ]}^{T} ∈ {C}^{{N}_{R} \times 1} \qquad ( 9 )$$

and received channel symbol vector of the p-th subcarrier during the k-th OFDM block as

$${y}_{p}^{( k )} = {[ \begin{matrix}{y}_{1 , p}^{( k )} & ⋯ & {y}_{{N}_{R} , p}^{( k )}\end{matrix} ]}^{T} ∈ {C}^{{N}_{R} \times 1} \qquad ( 10 )$$

Then, we express the system equation for the p-th subcarrier during the k-th OFDM block as

$${y}_{p}^{( k )} = \sqrt{\frac{ρ}{{N}_{T}}} {H}_{p}^{( k )} {x}_{p}^{( k )} + {v}_{p}^{( k )} , p = 1 , … , {N}_{c} \qquad ( 11 )$$

DLD-STFC Codeword Construction
Codeword Construction Procedure

For the first example, this is performed in two stages. Each stage is a complete LDC coding procedure itself and processes all complex symbols within the range of one DLD-STFC codeword. The first encoding stage is the frequency-time LDC stage (FT-LDC), in which LDC is performed across frequency (OFDM subcarriers) and time (OFDM blocks), enabling frequency and time diversity. The second encoding stage is the space-time LDC stage (ST-LDC), in which LDC is performed across space (N_{T} transmit antennas) and time (T OFDM blocks), enabling space and time diversity.

In the FT-LDC stage, there are D LDC matrix codewords. The d-th matrix codeword is of size

$$T \times {N}_{F}^{( d )} , d = 1 , … , D ,$$

where D is a multiple of N_{T}. The D LDC matrix codewords are grouped into N_{T} sub-groups. The m-th subgroup, which is allocated to the m-th antenna, has

$$D = {\sum }_{m = 1}^{{N}_{T}} {D}_{m} , m = 1 , … , {N}_{T}$$

(Note that the special case is Dₘ=D/N_{T}, m=1, . . . ,N_{T}) LDC matrix codewords. The i-th LDC codeword of the m-th subgroup in the FT-LDC stage is of size T×N_{F(m,i)}, i=1, . . . Dₘ, m=1, . . . , N_{T} where i=d(mod Dₘ). We use N_{F(i)}, which differs from

$${N}_{F}^{( d )}$$

in subscript i=1, . . . Dₘ, as the local index of FT-LDC for each transmit antenna, and superscript d=1, . . . ,D which stands for the global index for all D LDC codewords. For simplicity, LDC codewords in the FT-LDC stage are chosen with size constraints

$$\begin{matrix}{N}_{F ( m , i )} = {N}_{F ( i )} , & ( 12 ) \\ {\sum }_{i = 1}^{{D}_{m}} {N}_{F ( m , i )} = {N}_{C} , & ( 13 ) \\ {\sum }_{d = 1}^{D} {N}_{F}^{( d )} = {N}_{T} {N}_{C} . & ( 14 )\end{matrix}$$

where i=1, . . . ,Dₘ=1, . . . ,N_{T}. The size of a DLD-STFC codeword is N_{T}N_{C}T symbols. When Dₘ=D/N_{T}, m=1, . . . ,N_{T} are satisfied, one DLD-STFC codeword consists of D. STF blocks, each of which is of size N_{T}N_{F(i)}T,i=1, . . . ,Dₘ and are also constructed through DLD operation. Constraint (12) implies that the i-th LDC codewords of subgroups m=1, . . . ,N_{T}, are of the same matrix size. Further, we propose that the i-th LDC codewords of all the m-th subgroups, where m=1, . . . ,N_{T}, use the same LDC dispersion matrices and share the same subcarrier mappings, i.e., the same subcarrier indices of OFDM. Thus the FT-LDC coded symbols with the same subcarrier index among different transmit antennas share similar frequency-time diversity properties. The D LDC encoders of FT-LDC encode Q_{d}, d=1, . . . ,D data symbols in parallel. Each codeword is mapped to N_{T} transmit antennas and T OFDM blocks. Consequently, a three-dimensional array, U_{k,m,p}, k=1, . . . ,T, m=1, . . . ,N_{T}, p=1, . . . N_{c}, is created. In the FT-LDC stage, LDC symbol coding rate could be less than or equal to one.

In the ST-LDC stage, the signals from the FT-LDC stage are encoded per subcarrier. Thus there are N_{C} LDC encoders in this stage. Notationally, define the space time symbol matrix having been encoded in FT-LDC stage for the p-th OFDM subcarrier as UₚεC^{T×N}^{_{T}}, and [Uₚ]_{k,m}, U_{k,m,p}, k=1, . . . ,T, m=1, . . . ,N_{T}, p=1, . . . N_{C}.

Denote Uₚ^{vec}=vec(Uₚ), which is the source signal sequence of the p-th LDC codeword to be encoded in the ST-LDC stage, where p=1, . . . ,N_{C}. This stage further establishes the basis of space and time diversity. In this stage, LDC symbol coding rate is required to be one or full-rate. LD-STFC codeword construction

In the second example, an LDC system with a single combined STFC stage, termed LD-STFC is provided. This comprises only one complete LD coding procedure, and one LDC codeword is applied across multiple OFDM blocks and multiple antennas.

In one LD-STFC codeword, there are D LDC matrix codewords. The i-th matrix codeword is of size

$$T \times {N}_{LD}^{( i )} , i = 1 , … , D , and {N}_{LD}^{( i )}$$

is a multiple of N_{T}. We set constraint

$${N}_{C} = \frac{1}{{N}_{T}} {\sum }_{i = 1}^{D} {N}_{LD}^{( i )} \qquad ( 15 )$$

We partition the i-th LDC codeword into N_{T} matrix blocks, each of which is of size T×N_{LD(m,i)}, and

$${N}_{LD ( m , i )} = \frac{1}{{N}_{T}} {N}_{LD}^{( i )} \qquad ( 16 )$$

We map each T×N_{LD(m,i)} block into the m-th transmit antenna, where T denotes the number of OFDM blocks. Thus each LDC codeword is across multiple space (antennas), time (OFDM blocks) and frequency (OFDM subcarriers). The size of an LD-STFC codeword is N_{T}N_{C}T symbols, and one LD-STFC codeword consists of D STF blocks, each with size N_{T}N_{LD(m,i)}T,i=1, . . . ,D.
DLD-STFC System Receiver

In a DLD-STFC receiver, signal reception involves three steps. The first step estimates MIMO-OFDM signals for an entire DLD-STFC block, i.e., T OFDM blocks transmitted from N_{T} antennas. The second and third steps estimate source symbols of the ST-LDC and FT-LDC encoding stages, respectively. Following this, data bit detection is performed. In the following equations, where a small box appears, this corresponds to a “ˆ” in the figures.

Denote the d-th data source symbol vector with zero-mean, unit variance for the d-th LDC codeword of the FT-LDC stage as

$${s}^{( d )} = {[ {s}_{1}^{( d )} , {s}_{2}^{( d )} , … , {s}_{{Q}_{d}}^{( d )} ]}^{T}$$

where d=1, . . . ,D and Q_{d} denote the number of data source symbols encoded in the d-th LDC codeword

$${S}_{FT\_LDC}^{( d )}$$

of the FT-LDC stage and ŝ^{(d)} is the corresponding estimated data source symbol vector. In addition, denote the estimate of

$${S}_{FT\_LDC}^{( d )}$$

as

$${\hat{S}}_{FT\_LDC}^{( d )} .$$

Further, denote the estimated version of uₚ^{vex} as ûₚ^{vec}. Also denote estimated

$${S}_{ST\_LDC}^{( p )} as {\hat{S}}_{ST\_LDC}^{( d )} .$$

Denote the LDC encoding matrices needed to obtain

$${S}_{FT\_LDC}^{( d )} and {S}_{ST\_LDC}^{( p )} as {G}_{FT\_LDC}^{( d )} and {G}_{ST\_LDC}^{( p )} ,$$

respectively.

For simplicity of discussion, we consider the case that G_{FT}_{_{—}}_{LDC}^{(d)}=G_{FT}_{_{—}}_{LDC}, G_{ST}_{_{—}}_{LDC}^{(p)}=G_{ST}_{_{—}}_{LDC}, d=1, . . . ,D, p=1, . . . ,N_{C} are all unitary matrices and Q_{d}=Q,d=1, . . . ,D The covariance matrices of MIMO-OFDM channel symbols are then identity matrices. This can also be generalized to the case of non-identically distributed uncorrelated symbols.

Step 1—IMO-OFDM Signal Estimation

In the DLD-STFC decoding algorithm, LDC decoding is independent of MIMO-OFDM signal estimation. Thus the DLD-STFC system could be backwards-compatible with non-LDC-coded MIMO-OFDM systems. An advantage of DLD-STFC decoding is that channel coefficients may vary over multiple OFDM blocks.

Assuming that MIMO-OFDM symbols are normalized to unit variance, based on system equation (11), the minimum-mean-squared-error (MMSE) equalizer is given by

$$\begin{matrix}{G}_{p , ( k )}^{MMSE} = \sqrt{\frac{ρ}{{N}_{T}}} {{{C}_{{x}_{p}^{( k )}} ( {H}_{p}^{( k )} )}^{H} [ {I}_{{N}_{T}} + \frac{ρ}{{N}_{T}} {H}_{p}^{( k )} {{C}_{{x}_{p}^{( k )}} ( {H}_{p}^{( k )} )}^{H} ]}^{- 1} & ( 17 ) \\ {\hat{x}}_{p}^{( k )} = {G}_{p , ( k )}^{MMSE} {y}_{p}^{( k )} & ( 18 )\end{matrix}$$

where p=1, . . . ,N_{C},k=1, . . . ,T Cₓ_{ₚ}_{^{(k)}} is the covariance matrix of xₚ^{(k)}, which could be calculated using knowledge of

$${G}_{FT\_LDC}^{( d )} and {G}_{ST\_LDC}^{( p )} .$$

The first step estimation also can be other choices than MMSE, such as unbiased MMSE and good iterative estimation methods (e.g. interference cancellation). Basically, the channel symbols should be estimated in good quality.
Step 2—ST-LDC Block Signal Estimation

Reorganizing the results of the MIMO OFDM estimation into N_{C} estimated LDC matrix codewords

$${\hat{S}}_{ST\_LDC}^{( p )} ,$$

the estimates are

$${\hat{u}}_{p}^{vec} = {[ {G}_{ST\_LDC}^{( p )} ]}^{†} vec ( {\hat{S}}_{ST\_LDC}^{( p )} ) \qquad ( 19 )$$

where p=1, . . . ,N_{c}.
The second step estimation also can be other choices than the above zero-forcing method, such as MMSE, unbiased MMSE, and good iterative estimation methods (e.g. interference cancellation).
Step 3—FT-LDC Block Signal Estimation

Reorganizing the results of step 2 into D estimated LDC matrix codewords

$${\hat{S}}_{FT\_LDC}^{( d )} , d = 1 , … D$$

of the FT-LDC stage, we obtain

$${\hat{s}}^{( d )} = {[ {G}_{FT\_LDC}^{( d )} ]}^{†} vec ( {\hat{S}}_{FT\_LDC}^{( d )} ) \qquad ( 20 )$$

where d=1, . . . ,D.
The third step estimation also can be other choices than the above zero-forcing method, such as MMSE, unbiased MMSE, and good iterative estimation methods (e.g. interference cancellation). Also joint signal estimation and bit detection may be considered, such as maximum likelihood decoding, sphere decoding, iterative decoding.
Symbol Coding Rate for DLD-STFC, LD-STFC and MIMO-LDC-OFDM Systems

For DLD-STFC, assume that the d-th LDC matrix codeword of the FT-LDC stage is encoded using Q_{d} complex source symbols. For LD-STFC, assume that the d-th LDC matrix codeword is also encoded using Q_{d} complex source symbols. We also consider a third system with only a FT-LDC stage (each LDC codeword is not across multiple transmit antennas but transmitted on one antenna), termed MIMO-LDC-OFDM, i.e., straightforwardly applying LDC-OFDM as proposed in [13] to each antenna of a MIMO system.

We generally define the symbol coding rate of the three systems as

$${R}^{sym} = \frac{{\sum }_{i = 1}^{D} {Q}_{i}}{min \{ {N}_{T} , {N}_{R} \} T ( {N}_{C} - {N}_{P} )} , \qquad ( 21 )$$

where N_{P} is the number of subcarriers which are not used for data transmission, e.g. for pilot symbols.

We remark that, in some previous literature, such as [9], the symbol coding rate could also be defined as

$${R}^{sym} = \frac{{\sum }_{i = 1}^{D} {Q}_{i}}{T ( {N}_{C} - {N}_{P} )} \qquad ( 22 )$$

When full capacity is achieved, the symbol coding rate calculated using (21) is one, which provides an explicit relation between symbol coding rate and capacity; when full capacity is achieved, the symbol coding rate calculated using (22) is min {N_{T},N_{R}}. Note that, using (21), the “full rate” STFC design proposed in [9] has a symbol coding rate of one only when min {N_{T},N_{R}}=1. If min {N_{T},N_{R}}>1, the corresponding symbol coding rate is always less than one.

In the following discussion, we simply assume Nₚ=0. In the rest of the description, the definition of symbol coding rate (21) is used.

Layered System Structure and Complexity Issues

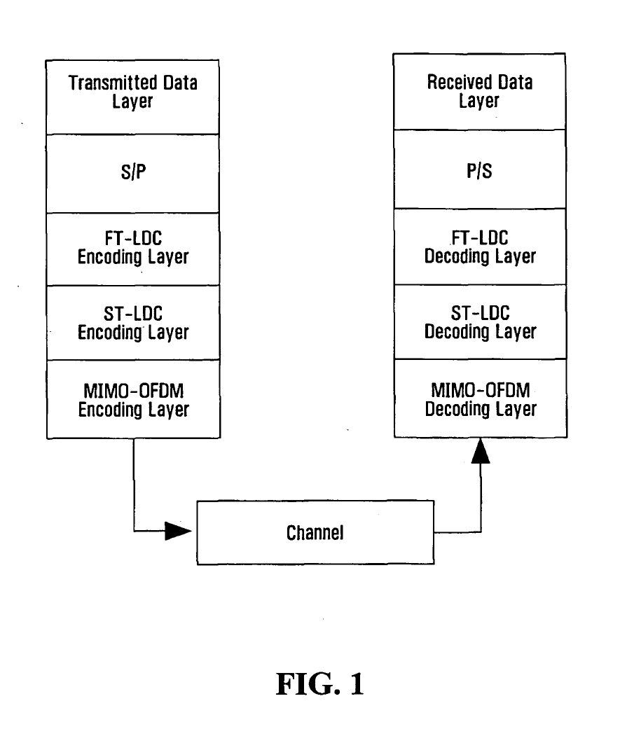

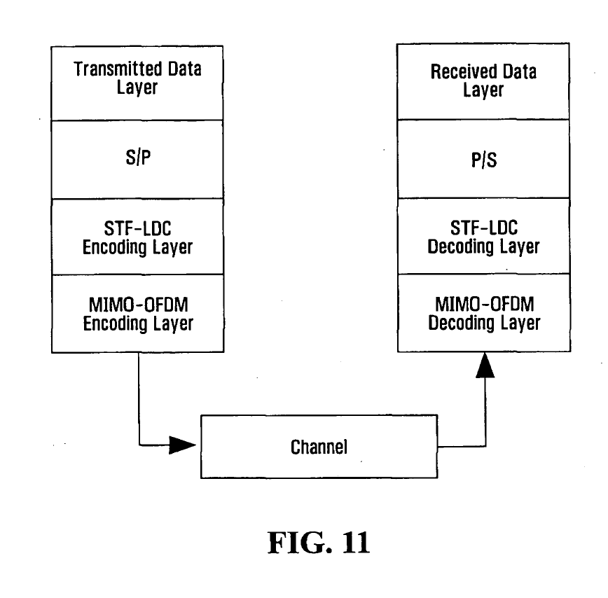

Both DLD-STFC and LD-STFC require coding matrices with the property that STFC codeword symbols are uncorrelated. Hence, the proposed STFC systems could be viewed as having the layered structure as shown in FIGS. 1 and 11 respectively, which enable the designed STFC systems to be compatible to non-LDC-coded MIMO-OFDM systems. There are at least two advantages of the layered system structure: (1) many existing signal estimation algorithms-developed for non-LDC-coded MIMO-OFDM systems are also applicable to DLD-STFC and LD-STFC systems, and (2) reduced complexity. In principle, it is possible to utilize a single STF block across all transmit antennas, subcarriers and OFDM blocks, and a rate-one STFC design would need codeword matrices of size N_{T}N_{C}T×N_{T}N_{C}T, which leads to extremely high computation complexity. Both DLD-STFC and LD-STFC receivers may advantageously employ the lower complexity multiple successive estimation stages instead of single-stage joint signal estimation (maximum likelihood or sphere decoding detectors) and LDC decoding. Due to layered structure, it is clear that the extra complexity of DLD-STFC and LD-STFC beyond MIMO-OFDM signal estimation is the encoding and decoding procedure, and per-data-symbol extra complexity is proportional to the corresponding symbol coding rate.

Diversity Aspects

Both DLD-STFC and LD-STFC are STF block-based designs. Based on the analysis of pairwise error probability, we determine the achievable diversity of these systems.

Since both DLD-STFC and LD-STFC include all LDC coding properties within either a T×N_{F(i)}N_{T} block or a T×N_{LD(m,i)}N_{T} block, in the following analysis, we consider a single block C⁽ⁱ⁾. The block C⁽ⁱ⁾ is created after encoding all the i-th FT-LDC codewords on all the transmit antennas and encoding the corresponding ST-LDC codewords in the case of DLD-STFC; or, after encoding all of the i-th LDC codewords across all transmit antennas and OFDM blocks in the case of the LD-STFC.

We use the unified notation N_{freq(i)} to represent both N_{F(i)} of DLD-STFC and N_{LD(m,i)} of LD-STFC and unified notation D_{STFB} (the number of STF block) to represent both Dₘ of DLD-STFC and D of LD-STFC. Thus the block C⁽ⁱ⁾,i=1, . . . ,D_{STFB} is of size T×N_{freq(i)}N_{T}. For simplicity, in block C⁽ⁱ⁾, consider the case that the subcarrier indices chosen from all the OFDM blocks are the same, and denote subcarrier indexes chosen {pₙ_{_{F(i)}}^{(m)}, n_{F(i)}=1₍ᵢ₎, . . . ,N_{freq(i)}, i=1, . . . ,D_{STFB},m=1, . . . ,N_{T}}. Denote the STF block C⁽ⁱ⁾ in matrix form as

$${C}^{( i )} = {[ \begin{matrix}{[ {C}^{( 1 , i )} ]}^{T} & {[ {C}^{( 2 , i )} ]}^{T} & ⋯ & {[ {C}^{( T , i )} ]}^{T}\end{matrix} ]}^{T} , \\ where \\ {C}^{( k , i )} = [ \begin{matrix}{c}_{{p}_{1 ( i )}^{( 1 )}}^{( k )} & {c}_{{p}_{1 ( i )}^{( 2 )}}^{( k )} & ⋯ & {c}_{{p}_{1 ( i )}^{( {N}_{T} )}}^{( k )} \\ {c}_{{p}_{2 ( i )}^{( 1 )}}^{( k )} & {c}_{{p}_{2 ( i )}^{( 2 )}}^{( k )} & ⋯ & {c}_{{p}_{2 ( i )}^{( {N}_{T} )}}^{( k )} \\ ⋮ & ⋮ & ⋰ & ⋮ \\ {c}_{{p}_{{N}_{freq ( i )}}^{( 1 )}}^{( k )} & {c}_{{p}_{{N}_{freq ( i )}}^{( 2 )}}^{( k )} & ⋮ & {c}_{{p}_{{N}_{freq ( i )}}^{( {N}_{T} )}}^{( k )}\end{matrix} ] \qquad ( 23 )$$

and cₚ_{_{nF(i)}}_{^{(m)}}^{(k)}, n_{F(i)}=1₍ᵢ₎, . . . , N_{freq(i)}, m=1, . . . ,N_{T} is the channel symbol of k-th OFDM block in STF block C⁽ⁱ⁾, the pₙ_{_{F(i)}}^{(m)}-th subcarrier from m-th transmit antenna.

Su and Liu [14] recently analyzed the diversity of STFC based on a STF block of size T×N_{C}N_{T}. Unlike [14], our analysis deals with only a single STF block of size of T×N_{freq(i)}N_{T}, where N_{freq(i)} is usually much less than N_{C} (note that [14] employs a different notation N instead of N_{C} to express the number of subcarriers in a OFDM block); in addition, the analysis in [14] is based on the assumption that the channel orders of all paths between transmit and receive antennas are the same. However, we assume frequency selective channel with orders that could be different among paths between transmit and receive antennas. Furthermore, the diversity analysis in [14] assumes no spatial correlation among transmit and receive antennas, while our analysis allows for arbitrary channel correlation among space (antennas), time (OFDM blocks) and frequency. In the following, we show that the upper bound diversity order for STF blocks of size T×N_{freq(i)}N_{T} could be equal to the upper bound diversity order for STF blocks of size T×N_{C}N_{T}. Thus, even with lower complexity, a smaller size STF block-based design is possible to achieve full diversity.

We write the system equation for block C⁽ⁱ⁾ as

$${R}^{( i )} = \sqrt{\frac{ρ}{{N}_{T}}} {M}^{( i )} {H}^{( i )} + {V}^{( i )} , \qquad ( 24 )$$

where receive signal vector R⁽ⁱ⁾ and noise vector V⁽ⁱ⁾ are of size N_{freq(i)}N_{R}T×1. The coded STF block channel symbol matrix M⁽ⁱ⁾ is of size N_{freq(i)}N_{R}T×N_{freq(i)}N_{T}N_{R}T, and M⁽ⁱ⁾=I_{N}_{_{R}}⊕[Mₗ⁽ⁱ⁾, . . . M_{N}_{_{T}}⁽ⁱ⁾], where

$${M}_{m}^{( i )} = diag ( {c}_{m , {p}_{1 ( i )}^{( m )}}^{( 1 )} , … , {c}_{m , {p}_{{N}_{freq ( i )}}^{( m )}}^{( 1 )} , … , {c}_{m , {p}_{1 ( i )}^{( m )}}^{( T )} , … , {c}_{m , {p}_{{N}_{freq ( i )}}^{( m )}}^{( T )} ) ,$$

i=1, . . . D_{STFB}, m=1, . . . N_{T}. The channel vector H⁽ⁱ⁾ is of size N_{freq(i)}N_{T}N_{R}T×1, and

$${H}^{( i )} = {[ \begin{matrix}{[ {H}_{1 , 1}^{( i )} ]}^{T} , … , {[ {H}_{{N}_{T} , 1}^{( i )} ]}^{T} , … , {[ {H}_{1 , 2}^{( i )} ]}^{T} , … , \\ {[ {H}_{{N}_{T} , 2}^{( i )} ]}^{T} , … , {[ {H}_{1 , {N}_{R}}^{( i )} ]}^{T} , … , {[ {H}_{{N}_{T} , {N}_{R}}^{( i )} ]}^{T}\end{matrix} ]}^{T} ,$$

where

$$[ {H}_{m , n}^{( i )} ]$$

is of size N_{freq(i)}T×1

$${H}_{m , n}^{( i )} = {[ \begin{matrix}{H}_{m , n , {p}_{1 ( i )}^{( m )}}^{( 1 )} , {H}_{m , n , {p}_{2 ( i )}^{( m )}}^{( 1 )} , … , {H}_{m , n , {p}_{{N}_{freq ( i )}}^{( m )}}^{( 1 )} , … , \\ {H}_{m , n , {p}_{1 ( i )}^{( m )}}^{( T )} , {H}_{m , n , {p}_{2 ( i )}^{( m )}}^{( T )} , … , {H}_{m , n , {p}_{{N}_{freq ( i )}}^{( m )}}^{( T )}\end{matrix} ]}^{T}$$

and

$${H}_{m , n , {p}_{{n}_{F ( i )}}^{( m )}}^{( k )}$$

is the path gain of k-th OFDM block, the

$${p}_{{n}_{F} ( i )}^{( m )} - th$$

subcarrier for block C⁽ⁱ⁾between the m-th transmit antenna and the n-th receive antenna. Thus, according to (6), we get

$${H}_{m , n , {p}_{{n}_{F ( i )}}^{( m )}}^{( k )} = {[ {w}_{{p}_{{n}_{F ( i )}}^{( m )}} ]}^{T} {h}_{m , n}^{( k )} \qquad ( 25 )$$

Consider the pair of matrices M⁽ⁱ⁾ and \tilde{M}⁽ⁱ⁾ corresponding to two different STF blocks C⁽ⁱ⁾ and \tilde{C}⁽ⁱ⁾. The upper bound pairwise error probability [15] is

$$P ( {M}^{( i )} \to {\tilde{M}}^{( i )} ) \leq ( \begin{matrix}2 r - 1 \\ r\end{matrix} ) {( {\prod }_{a = i}^{r} {γ}_{a} )}^{- 1} {( \frac{ρ}{{M}_{t}} )}^{- r} \qquad ( 26 )$$

where r is the rank of (M⁽ⁱ⁾−\tilde{M}⁽ⁱ⁾)R_{H(i)}(M⁽ⁱ⁾−\tilde{M}⁽ⁱ⁾)^{H}, and R_{H}_{⁽ⁱ⁾}=E{H⁽ⁱ⁾[H⁽ⁱ⁾]^{H}} is the correlation matrix of vector H⁽ⁱ⁾, R_{H}_{⁽ⁱ⁾} is of size, γ_{α},α=1, . . . , r are the non-zero eigenvalues of
Λ⁽ⁱ⁾=(M⁽ⁱ⁾−\tilde{M}⁽ⁱ⁾)R_{H}_{⁽ⁱ⁾}(M⁽ⁱ⁾−\tilde{M}⁽ⁱ⁾)^{H}
Then the corresponding rank and product criteria are
1) Rank criterion: The minimum rank of Λ⁽ⁱ⁾over all pairs of different matrices M⁽ⁱ⁾ and \tilde{M}⁽ⁱ⁾ should be as large as possible.
2) Product criterion: the minimum value of the product

$${\prod }_{a = i}^{r} {γ}_{a}$$

over all pairs of different M⁽ⁱ⁾ and \tilde{M}⁽ⁱ⁾ should be maximized.

To further analyze diversity properties of coded STF blocks, it is helpful to compute R^{H}_{⁽ⁱ⁾}=E{H⁽ⁱ⁾[H⁽ⁱ⁾]^{H}} is the correlation matrix of vector H⁽ⁱ⁾.

The frequency domain channel vector for each transmit and receive antenna path in matrix form is,

$${H}_{m , n}^{( i )} = ( {I}_{T} ⊗ {W}^{( m , i )} ) {h}_{m , n} \\ where \\ {W}^{( m , i )} = {[ {w}_{{p}_{1 ( i )}^{( m )}} , … , {w}_{{p}_{{N}_{freq ( i )}}^{( m )}} ]}^{T} and \\ {h}_{m , n} = [ {[ {h}_{m , n}^{( 1 )} ]}^{T} , … , {[ {h}_{m , n}^{( T )} ]}^{T} ] , \\ m = 1 , … , {N}_{T} , n = 1 , … , {N}_{R} \qquad ( 27 )$$

The frequency domain channel vector for the whole coded STF block is written as,

$$\begin{matrix}{H}^{( i )} = {W}^{( i )} h \\ where \\ {W}^{( i )} = {I}_{{N}_{a}} ⊗ diag \{ ( {I}_{T} ⊗ {W}^{( 1 , i )} ) , … , ( {I}_{T} ⊗ {W}^{( {N}_{T} , i )} ) \} \\ and \\ h = {[ {[ {h}_{1 , 1} ]}^{T} , … , {[ {h}_{{N}_{T} , 1} ]}^{T} , {… [ {h}_{1 , {N}_{R}} ]}^{T} , … , {[ {h}_{{N}_{T} , {N}_{R}} ]}^{T} ]}^{T} . & ( 28 ) \\ Thus , \\ \begin{matrix}{R}_{{H}^{( i )}} = E \{ {W}^{( i )} {h [ {W}^{( i )} h ]}^{H} \} \\ = {W}^{( i )} E {\{ {h [ h ]}^{H} \} [ {W}^{( i )} ]}^{H} \\ = {W}^{( i )} {Φ [ {W}^{( i )} ]}^{H}\end{matrix} \\ where \\ Φ = E \{ {h [ h ]}^{H} \} . & ( 29 )\end{matrix}$$

Note that arbitrary channel correlation among space, time and frequency may occur in Φ.

In general, for matrices A and B, we know
rank(AB)≦min {rank(A),rank(B)} (30)
Thus,
rank(Λ⁽ⁱ⁾)≦
min {rank(M⁽ⁱ⁾−\tilde{M}⁽ⁱ⁾), rank(R_{H}_{⁽ⁱ⁾})} (31)

To maximize the rank of R_{H}_{⁽ⁱ⁾}, it is sufficient to maximize the rank of W⁽ⁱ⁾ and the rank of Φ. To maximize the rank of W⁽ⁱ⁾, it is sufficient to maximize the ranks of N_{freq(i)}×(L+1) matrices W^{(m,i)} respectively, where m=1, . . . ,N_{T}. Thus we need to choose
N_{freq(i)}≧L+1≧L_{m,n}+1 (32)
When

$${p}_{{n}_{F ( i )}}^{( m )} = {p}_{{1}_{( i )}}^{( m )} + b ( {n}_{F} - 1 ) , {n}_{{F}_{( i )}} = {1}_{( i )} , … , {N}_{freq ( i )} , {N}_{freq ( i )} \geq L + 1 , where {p}_{{n}_{F ( i )}}^{( m )} \leq {N}_{C}$$

and b is a positive integer, W^{(m,i)} could achieve maximum rank L+1, then the rank of W^{(m,i)} could be maximized to TN_{T}N_{R}(L+1). The choice of interval b is discussed in [16] and [14]. It can be shown that the maximal achievable rank of Φ is

$$T {\sum }_{m = 1}^{{N}_{T}} {\sum }_{n = 1}^{{N}_{R}} ( {L}_{m , n} + 1 ) .$$

Hence, the maximal achievable rank of R_{H}_{⁽ⁱ⁾} is

$$T {\sum }_{m = 1}^{{N}_{T}} {\sum }_{n = 1}^{{N}_{R}} ( {L}_{m , n} + 1 ) .$$

If L_{m,n}=L holds for all m=1, . . . ,N_{T.}n=1, . . . ,N_{R}, R_{H}_{⁽ⁱ⁾} can have a maximal achievable rank N_{T}N_{R}T(L+1). We know M⁽ⁱ⁾−\tilde{M}⁽ⁱ⁾ is of a size N_{freq(i)}N_{R}T×N_{freq(i)}N_{T}N_{R}T. Thus rank (M⁽ⁱ⁾−\tilde{M}⁽ⁱ⁾)≦N_{freq(i)}N_{R}T.

Consequently, the achievable diversity order of the coded STF block satisfies

$$rank ( {Λ}^{( i )} ) \leq min \{ {N}_{freq ( i )} {N}_{R} T , T {\sum }_{m = 1}^{{N}_{T}} {\sum }_{n = 1}^{{N}_{R}} ( {L}_{m , n} + 1 ) \} \qquad ( 33 )$$

If the time correlation is independent of the space and frequency correlation, the upper bound in (33) becomes

$$min \{ {N}_{freq ( i )} {N}_{R} T , rank ( {R}_{i} ) {\sum }_{m = 1}^{{N}_{T}} {\sum }_{n = 1}^{{N}_{R}} ( {L}_{m , n} + 1 ) \} , \qquad ( 34 )$$

where Rₜ is a T×T time correlation matrix, and N_{freq(i)}≧L+1.

The above analysis has revealed that it is possible for a properly chosen STF block design of size T×N_{freq(i)}N_{T} to achieve a diversity order up to

$$T {\sum }_{m = 1}^{{N}_{T}} {\sum }_{n = 1}^{{N}_{R}} ( {L}_{m , n} + 1 ) ,$$

which is more general than the upper bound diversity order N_{T}N_{R}T(L+1) provided in [14], since we consider the varying frequency selective channel orders of different transmit-receive antenna paths. The necessary condition that STF block design achieves a certain diversity order is that the rank of the channel correlation matrix be equal to the diversity order of the STF block.

The STF blocks C⁽ⁱ⁾,i=1, . . . ,D_{STFB} of both DLD-STFC and LD-STFC designs are across multiple time-varying OFDM blocks, multiple transmit antennas and multiple subcarriers, and thus have the potential to achieve full diversity order. The smaller block-size STFC design may in fact achieve high performance with lower complexity. However, the actual diversity order achieved is based on the specific LDC design chosen. In [10], diversity order is not optimized. In [11], both capacity and error probability are used as criteria but the diversity analysis is based on quasi-static flat fading space-time channels. The proposed LD-STFC has diversity determined by the a single LDC procedure operating in 3-D STF space.

In contrast, DLD-STFC includes two complete LDC procedures, operating over FT and ST 2-D planes. If the FT-LDC and ST-LDC procedures achieve full diversity order, then DLD-STFC can achieve diversity order up to

$$T {\sum }_{m = 1}^{{N}_{T}} {\sum }_{n = 1}^{{N}_{R}} ( {L}_{m , n} + 1 ) ,$$

where N_{R} is independent of specific STFC design. In addition, in DLD-STFC, source symbols for ST-LDC are coded FT-LDC symbols. Thus time dependency is already included, and therefore the upper bound additional maximal diversity order for ST-LDC is N_{T} instead of N_{T}T. DLD-STFC operates on much smaller 2-D FT-LDC and ST-LDC blocks instead of the larger 3-D STF blocks.
Design Criteria Based on Union Bound

The error union bound (EUB), an upper bound on the average error probability, is an average of the pairwise error probabilities between all pairs of codewords. Based on EUB, we analyze an LDC coding stage across multiple transmit antennas, i.e., the ST-LDC stage of DLD-STFC and the STF stage of LD-STFC. In [17], space time codes are analyzed based on EUB, where channel gains are assumed constant over time during the entire space time codewords. We provide an EUB analysis for MIMO OFDM channels whose gains may vary over the time duration of an LDC codeword, e.g., over different OFDM blocks. Basically, the EUB can be written as

$${P}_{U} = {\sum }_{a = 1}^{{N}_{B}} {p}_{a} {\sum }_{b \neq a}^{{N}_{B}} {PEP}_{ab} \leq ( N - 1 ) {max}_{ab} {PEP}_{ab} \qquad ( 35 )$$

where pₐ is the probability that LDC codeword X^{(a)} was transmitted, PEP_{ab} is the probability that receiver decides X^{(b)} when X^{(a)} is actually transmitted, and N_{B} is the LDC code book size.

We write a unified system equation for one STF block as

$${R}_{U} = {H}_{U} {\sum }_{q = 1}^{Q} vec ( {A}_{q} ) {s}_{q} + {V}_{U} , \qquad ( 36 )$$

where R_{U} and V_{U} are the received signal and additive noise vectors, respectively, A_{q},q=1, . . . ,Q are linear dispersion matrices, s_{q},q=1, . . . ,Q are source symbols for this LDC coding procedure, and H_{U} denotes the channel matrix corresponding to different code mappings. Note that the entries of R_{U} and V_{U} consist of entries of receive signals and complex noise in previous sections multiplying a factor

$$\sqrt{\frac{{N}_{T}}{ρ}} .$$

In the following, the setting of subcarrier indices is the same as that above. For LD-STFC, H_{U}=H_{LD}_{_{—STFC}}⁽ⁱ⁾, and

$${H}_{LD\_STFC}^{( i )} = [ \begin{matrix}{H}_{LD\_STFC ( 1 , 1 )}^{( i )} & ⋯ & {H}_{LD\_STFC ( {N}_{T} , 1 )}^{( i )} \\ ⋮ & ⋰ & ⋮ \\ {H}_{LD\_STFC ( 1 , {N}_{R} )}^{( i )} & ⋯ & {H}_{LD\_STFC ( {N}_{T} , {N}_{R} )}^{( i )}\end{matrix} ]$$

$$where$$

$${H}_{LD\_STFC ( m , n )}^{( i )} = diag ( {H}_{m , n , {p}_{{1}_{( m , i )}}^{( m )}}^{( 1 )} , … , {H}_{m , n , {p}_{{1}_{( m , i )}}^{( m )}}^{( T )} , … , {H}_{m , n , {p}_{{N}_{LD ( m , i )}}^{( m )}}^{( 1 )} , … , {H}_{m , n , {p}_{{N}_{LD ( m , i )}}^{( m )}}^{( T )} )$$

and

$${p}_{{n}_{F ( i )}}^{( m )} , {n}_{F ( i )} = {1}_{( i )} , … , {N}_{LD ( m , i )}$$

are the subcarrier indices of the partition of the i-th LDC on the m-th transmit antenna.

For the ST-LDC stage of DLD-STFC,

$${H}_{U} = {H}_{DLD\_STFC \_ST}^{( {p}_{{n}_{F ( i )}} )} , with$$

$${H}_{DLD\_STFC \_ST}^{( {p}_{{n}_{F ( i )}} )} = [ \begin{matrix}{H}_{DLD\_STFC \_ST ( 1 , 1 )}^{( {p}_{{n}_{F ( i )}} )} & ⋯ & {H}_{DLD\_STFC \_ST ( {N}_{T} , 1 )}^{( {p}_{{n}_{F ( i )}} )} \\ ⋮ & ⋰ & ⋮ \\ {H}_{DLD\_STFC \_ST ( 1 , {N}_{R} )}^{( {p}_{{n}_{F ( i )}} )} & ⋯ & {H}_{DLD\_STFC \_ST ( {N}_{T} , {N}_{R} )}^{( {p}_{{n}_{F ( i )}} )}\end{matrix} ]$$

$$where$$

$${H}_{DLD\_STFC \_ST ( m , n )}^{( {p}_{{n}_{F ( i )}} )} = diag ( {H}_{m , n , {p}_{{n}_{F ( i )}}^{( m )}}^{( 1 )} , … , {H}_{m , n , {p}_{{n}_{F ( i )}}^{( m )}}^{( T )} )$$

and

$${p}_{{n}_{F ( i )}}^{( m )} , {n}_{F ( i )} = {1}_{( i )} , ⋯ , {N}_{F ( i )}$$

are the subcarrier indices of the partition of the i-th LDC on the m-th transmit antenna.

Denote the channel-weighted inner product between two dispersion matrices as

$$\begin{matrix}{Ω}_{p , q} = {〈 vec ( {A}_{p} ) , vec ( {A}_{q} ) 〉}_{{H}_{u}} & ( 37 ) \\ = \frac{1}{2} ( \begin{matrix}Tr [ {{[ vec ( {A}_{p} ) ]}^{H} [ {H}_{U} ]}^{H} {H}_{U} vec ( {A}_{q} ) ] + \\ Tr [ {{[ vec ( {A}_{q} ) ]}^{H} [ {H}_{U} ]}^{H} {H}_{U} vec ( {A}_{p} ) ]\end{matrix} ) & \\ = Tr ( {{[ vec ( {A}_{p} ) ]}^{H} [ {H}_{U} ]}^{H} {H}_{U} vec ( {A}_{q} ) ) & \\ = Tr ( {H}_{U} {{vec ( {A}_{p} ) [ vec ( {A}_{q} ) ]}^{H} [ {H}_{U} ]}^{H} ) & \\ and & \\ {Ω}_{q , q} = {‖ {H}_{U} vec ( {A}_{q} ) ‖}_{F}^{2} \geq 0 & ( 38 )\end{matrix}$$

where p,q=1, . . . ,Q.

Denote squared pairwise Euclidean distance between two received codewords X^{(a)} and X^{(b)} and for the given channel H_{U} as

$$\begin{matrix}{D}_{a , b} = {‖ {H}_{U} ( {X}^{( a )} - {X}^{( b )} ) ‖}_{F}^{2} \\ = {‖ {\sum }_{q = 1}^{Q} [ [ {H}_{U} vec ( {A}_{q} ) ] ( {s}_{q}^{( a )} - {s}_{q}^{( b )} ) ] ‖}_{F}^{2} \\ = {\sum }_{q}^{Q} [ {Q}_{q , q} {\vert {e}_{q}^{( a , b )} \vert}^{2} ] + 2 Re \{ {\sum }_{q = 1}^{Q} {\sum }_{p < q}^{Q} [ {{Ω}_{p , q} [ {e}_{p}^{( a , b )} ]}^{*} {e}_{q}^{( a , b )} ] \} , \\ where \\ {e}_{q}^{( a , b )} = {s}_{q}^{( a )} - {s}_{q}^{( b )}\end{matrix} \qquad ( 39 )$$

is the difference between source symbol sequences (a) and (b) at the q-th position.

The pairwise error probability conditioned on channel H_{U} is [18]

$${PEP}_{ab \vert {H}_{U}} = Q ( \sqrt{\frac{η}{2} {D}_{a , b}} ) \qquad ( 40 )$$

where η denotes SNR, and

$$η = \frac{ρ}{{N}_{T}} .$$

The EUB conditioned on channel H_{U} is [17]

$${P}_{U \vert {H}_{U}} = {\sum }_{a = 1}^{{N}_{B}} {p}_{a} {\sum }_{b \neq a}^{{N}_{B}} Q ( \sqrt{\frac{η}{2} {D}_{a , b}} ) \qquad ( 41 )$$

As in [17], denote

$$\begin{matrix}{Δ}_{1}^{( a , b )} = \frac{η}{2} {\sum }_{q}^{Q} [ {Ω}_{q , q} {\vert {e}_{q}^{( a , b )} \vert}^{2} ] & ( 42 ) \\ and & \\ {Δ}_{2}^{( a , b )} = \frac{η}{2} 2 Re \{ {\sum }_{q = 1}^{Q} {\sum }_{p < q}^{Q} [ {{Ω}_{p , q} [ {e}_{p}^{( a , b )} ]}^{*} {e}_{q}^{( a , b )} ] \} & ( 43 )\end{matrix}$$

Using (37), (38), (39), (41), (42) and (43), we obtain [17]

$${P}_{U \vert {H}_{U}} = {\sum }_{a = 1}^{{N}_{B}} {p}_{a} {\sum }_{b \neq a}^{{N}_{B}} Q ( \sqrt{{Δ}_{1}^{( a , b )} + {Δ}_{2}^{( a , b )}} ) \qquad ( 44 )$$

We have the following remarks.
1. The input source symbol sequences are real in [17], while the input source symbol sequences are complex in this section. Nevertheless, we assume that input complex source symbol sequences are uncorrelated. For QAM constellations, the minimum error events [17] are in terms of real or imaginary coordinates, while in this section, the error would be complex symbol.
2. Although (41), (42), (43), (44) are similar expressions in

we have redefined D_{a,b}, Ω_{p,q}, Δ₁^{(a,b)} and Δ₂^{(a,b)} based on a channel model in which channel coefficients in the frequency domain may vary over time within one STFC codeword. The quantities Dᵢⱼ, Ω_{k,i}, Δ₁^{(i,j)}, and Δ₂^{(i,j)} defined in [17] are only suitable for a channel with constant coefficients over time within one space time matrix codeword, i.e. block fading channels.

If all source symbols are equally likely, i.e.

$${p}_{a} = \frac{1}{N}$$

for all a, the following two lemmas apply. Lemma 1 in this section, extended from Lemma 2 for real input sequences in [17], is our result under consideration of complex input sequences. Lemma 2 appears [17], and applies to both real and complex inputs.
Lemma 1: For uncorrelated complex input sequences, [by carefully selecting terms in (44), one can always pair up terms Q(\sqrt{Δ₁^{(a,b}^{₁}⁾+Δ₂^{(a,b}^{₁}⁾}) and Q(\sqrt{Δ₁^{(a,b}^{₂}⁾+Δ₂^{(a,b}^{₂}⁾}) as follows

$$θ = \frac{g}{{N}_{B}} [ Q ( \sqrt{{Δ}_{1} + {Δ}_{2}} ) + Q ( \sqrt{{Δ}_{1} - {Δ}_{2}} ) ] , \qquad ( 45 )$$

where g is an integer denoting the number of such pairs.
Lemma 2: [17] For a given Δ₁, θ in (45) is minimized if and only if Δ₂=0.

For linear dispersion codes in 2-D rapid fading channels with realization Hu, we have the following EUB-based optimal design criterion:

Proposition 1: For uncorrelated complex source put symbol sequences, consider LDC with T×M dispersion matrices A_{q}, q=1, . . . ,Q used for real and imaginary parts of source symbols, and
A_{q}[A_{q}]^{H}=I_{T}, if T≦M
[A_{q}]^{H}A_{q}=I_{M}, if T≧M
Union bound P_{U|H}_{_{U}} achieves a minimum iff the matrices satisfy
Ω_{p,q}=Tr([vec(Aₚ)]^{H}[H_{U}]^{H} H_{U}vec(A_{q}))=0 (46)
for any 1≦p≠q≦Q.
Proposition 1 is equivalent to requiring vec(Aₚ) and vec(A_{q}) to be pairwise orthogonal for any weighting matrix Θ=[H_{U}]^{H} H_{U}. Note that for quasi-static (block fading) channels, the result is of the form [17]
Ω_{p,q}=Tr([Aₚ]^{H}[H_{U}]^{H}H_{U}A_{q})=0 (47)
which is based on the assumption that the input sequences are real in [17]. Our new result is that the above condition (47) for quasi-static channels also ensures union bound P_{U|H}_{_{U}} to achieve a minimum in block fading channels.
Based on the average channel H_{U}, we also have the following suboptimal criterion for unknown channels at the transmitter.
Theorem 1: For uncorrelated complex source input symbol sequences, consider LDC with T×M dispersion matrices and A_{q},q=1, . . . ,Q corresponding to real and imaginary parts of source symbols, satisfying
A_{q}[A_{q}]^{H}=I_{T}, if T≦M
[A_{q}]^{H}A_{q}=I_{M}, if T≧M
Assume that the auto-correlation of channel gains in the 2-D channel dominates the cross-correlation of any two different channel gains in 2-D channels. Assume that the auto-correlation of channel gains for each channel element in the channel matrix are the same. The part of the union bound P_{U|H}_{_{U}} related to the auto-correlation of channel gains in the 2-D channel based on averaged channel realizations is minimized if
Tr[vec(Aₚ)[vec(A_{q})]^{H}]=0 (48)
for any 1≦p≠q≦Q.
The above Theorem 1 provides a new EUB design criterion for LDC. A class of recently proposed rectangular LDC, termed uniform LDC (U-LDC), meets this union bound criterion, which is shown [19].
Further, we conjecture that in block fading channels, provided that uncorrelated complex source input symbol sequences are used, The union bound P_{U|H}_{_{U}} based on averaged channel realizations is minimized if
Tr[Aₚ[A_{q}]^{H}]=0 (49)
for any 1≦p≠q≦Q.
Performance
Uniform Linear Dispersion Codes

We have recently proposed a class of rate-one rectangular LDC of arbitrary size, called uniform linear dispersion codes (U-LDC) [19], which are an extension of a class of rate-one square LDC of arbitrary size proposed by Hassibi and Hochwald as shown in Eq. (31) of [10]. We describe U-LDC here, since U-LDC are extensively used as component LDCs in simulations. U-LDCs have the following important properties [19]:

Property 1: Consider U-LDC with arbitrary size T×M dispersion matrices A_{q},q=1, . . . ,TM. The encoding matrix G_{LDC}=[vec(A₁) . . . vec(A_{Q})] is unitary, i.e., G_{LDC}[G_{LDC}]^{H}=I_{TM}.

We remark that according to Theorem 1 of [11], the above unitary property ensures that U-LDC is capacity-optimal in block fading space time channels. In addition, this property ensures the uncorrelatedness of coded symbols, a preferred feature of the multiple-layer system designs described.

Property 2: U-LDC of size T×M dispersion matrices A_{q},q=1, . . . ,TM satisfy the union bound constraint for rapid fading channels required for Theorem 1 above, i.e.,
Tr[vec (Aₚ)[vec(A_{q})]^{H}]=0
for any 1≦p≠q≦Q.

The construction of uniform linear dispersion codes is as follows:
1) The Case of T≦M Denote

$$D = [ \begin{matrix}1 & 0 & ⋯ & 0 \\ 0 & {ⅇ}^{j \frac{2 π}{T}} & ⋯ & 0 \\ ⋮ & ⋮ & ⋰ & ⋮ \\ 0 & 0 & ⋮ & {ⅇ}^{j \frac{2 π ( T - 1 )}{T}}\end{matrix} ] , \qquad Π = [ \begin{matrix}0 & 0 & ⋯ & 0 & 1 \\ 1 & 0 & ⋯ & 0 & 0 \\ 0 & 1 & ⋰ & ⋯ & 0 \\ ⋮ & ⋮ & ⋰ & ⋰ & ⋮ \\ 0 & 0 & ⋯ & 1 & 0\end{matrix} ] ,$$

$$Γ = [ \begin{matrix}1 & 0 & ⋯ & ⋯ & 0 & ⋯ & 0 \\ 0 & 1 & ⋰ & ⋯ & 0 & ⋯ & 0 \\ ⋮ & ⋰ & ⋰ & ⋰ & ⋮ & ⋮ & ⋮ \\ 0 & 0 & ⋰ & 1 & 0 & ⋯ & 0 \\ 0 & 0 & ⋯ & 0 & 1 & ⋯ & 0\end{matrix} ] ,$$

where D is of size T×T, Π is of size M×M, and Γ is of size T×M.

The T×M LDC dispersion matrices are:

$${A}_{M ( k - 1 ) + l} = {B}_{M ( k - 1 ) + l} = \frac{1}{\sqrt{T}} {D}^{k - 1} Γ {Π}^{l - 1} \qquad ( 50 )$$

where k=1, . . . ,T and l=1, . . . ,M.
2) Case of T>M Denote

$$D = [ \begin{matrix}1 & 0 & ⋯ & 0 \\ 0 & {ⅇ}^{j \frac{2 π}{M}} & ⋯ & 0 \\ ⋮ & ⋮ & ⋰ & ⋮ \\ 0 & 0 & ⋰ & {ⅇ}^{j \frac{2 π ( M - 1 )}{M}}\end{matrix} ] , \qquad Γ = [ \begin{matrix}1 & 0 & ⋯ & 0 & 0 \\ 0 & 1 & ⋰ & 0 & 0 \\ ⋮ & ⋰ & ⋰ & ⋰ & ⋮ \\ 0 & 0 & ⋰ & 1 & 0 \\ 0 & 0 & ⋯ & 0 & 1 \\ ⋮ & ⋮ & ⋮ & ⋮ & ⋮ \\ 0 & 0 & ⋯ & 0 & 0\end{matrix} ]$$

where D is of size M×M, Π, defined earlier, is of size T×T, and Γ is of size T×M

The T×M LDC dispersion matrices are:

$${A}_{M ( k - 1 ) + l} = {B}_{M ( k - 1 ) + l} = \frac{1}{\sqrt{M}} {Π}^{k - 1} Γ {D}^{l - 1} \qquad ( 51 )$$

where k=1, . . . ,T and l=1, . . . ,M.
Simulation Setup

Perfect channel knowledge (amplitude and phase) is assumed at the receiver but not at the transmitter. The number of subcarriers per OFDM block, N_{C}, is 32. In all DLD-STFC, LD-STFC and MIMO-LDC-OFDM system simulations, all LDC codewords are encoded either using Eq. (31) of [10] or U-LDC.

The symbol coding rates of all systems are unity, so compared with non-LDC-coded MIMO-OFDM systems, no bandwidth is lost. The sizes of all LDC codewords in the FT-LDC stage of DLD-STFC and MIMO-LDC-OFDM are identically T×N_{F}, as are the sizes of LDC codewords in the ST-LDC stage of DLD-STFC, T×N_{T}, as are the sizes of LDC codewords in LD-STFC, T×N_{LD}, where N_{LD}=N_{LD}_{ₘ}N_{T}, and N_{LD}_{ₘ} is the size of the subcarrier partition on each transmit antenna for an LDC codeword.

An evenly spaced LDC subcarrier mapping (ES-LDC-SM) for the FT-LDC of DLD-STFC and MIMO-LDC-OFDM, as well as LD-STFC, is used in simulations unless indicated otherwise. In ES-LDC-SM, subcarriers chosen within one LDC codeword are evenly spaced by maximum available intervals for all different LDC codewords. We note that ES-LDC-SM ensures W^{(m,i)}, defined above, to be of full rank, to achieve maximum diversity order. For comparison purposes, another subcarrier mapping, called connected LDC subcarrier mapping (C-LDC-SM), is tested for the FT-LDC of DLD-STFC. In C-LDC-SM, subcarriers within one LDC codeword are chosen to be adjacent.

Since the aim of reaching maximal achievable diversity may require non-square FT-LDC or ST-LDC, U-LDC is utilized for DLD-STFC.

The frequency selective channel has L+1 paths exhibiting an exponential power delay profile, and a channel order of L=3 is chosen. Data symbols use QPSK modulation in all simulations. The number of antennas are set to N_{R}=N_{T}. Except where noted, no spatial correlation is assumed in simulations. The signal-to-noise-ratio (SNR) reported in all figures is the average symbol SNR per receive antenna.

The matrix channel is assumed to be constant over different integer numbers of OFDM blocks, and i.i.d. between blocks. We term this interval as the channel change rate (CCR).

C. Performance Comparison Among DLD-STFC with Two Different LDC Subcarrier Mappings and Non-LDC-Coded MIMO-OFDM

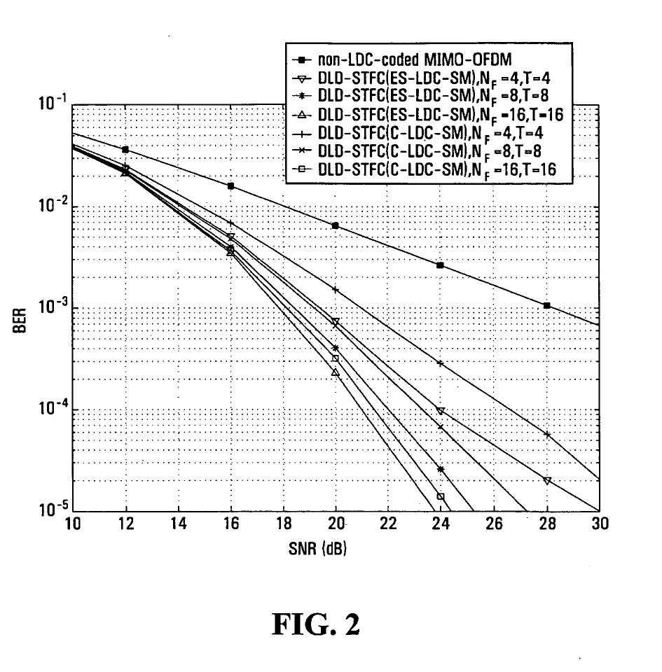

FIG. 2 shows the performance comparison of Bit Error Rate (BER) vs. SNR among DLD-STFC with two different LDC subcarrier mappings, ES-LDC-SM and C-LDC-SM, and C-LDC-SM, and non-LDC-coded MIMO-OFDM for various combinations of T in two transmit and two receive (2×2) MIMO antennas systems.

Clearly, in frequency-selective Rayleigh fading channels, BER performance of DLD-STFC is notably better than that of non-LDC-coded MIMO-OFDM. The larger the dispersion matrices used, the greater the performance improvement, at a cost of increased decoding delay. The simulations use U-LDC based DLD-STFC. Though we do not claim that U-LDC are full diversity codes, we conjecture that U-LDC based STFC can achieve close to full diversity performance for PSK constellations. This superior performance is also due to U-LDC satisfying the EUB.

It is clearly observed that the performance of DLD-STFC with ES-LDC-SM is notably better than that of DLD-STFC with C-LDC-SM. Thus, LDC subcarrier mappings influence the performance of DLD-STFC.

D. Effect of Channel Dynamics in DLD-STFC

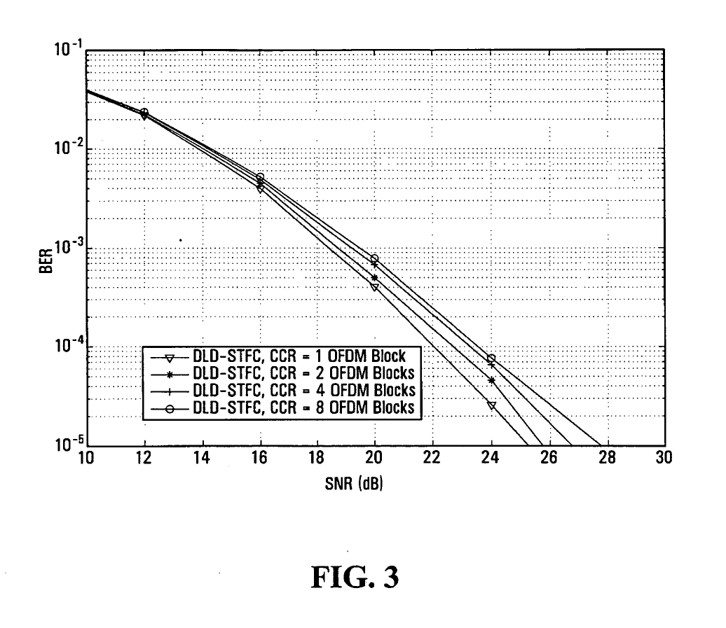

FIG. 3 depicts performance of DLD-STFC with ES-LDC-SM under various different rates of channel parameter change in a 2×2 MIMO system. Note that different CCRs roughly correspond to different degrees of temporal channel correlation over OFDM blocks. Two extreme cases were tested: when CCR=1, i.e., channel correlation over time is zero, full time diversity is available in the channel. When CCR=T, i.e., channel correlation over time is unity, no time diversity is available in the channel. As discussed in above, STFC diversity order is maximized only if the channel provides block-wise temporal independence.

As shown in FIG. 3, the performance of DLD-STFC is significantly influenced by channel dynamics, i.e., time correlation. At high SNRs, the faster the channel changes, the better the performance. This indicates that DLD-STFC effectively exploits available temporal diversity across multiple OFDM blocks. In the future, testing on a more accurate model of temporal channel dynamics is needed to obtain a more accurate assessment.

E. Performance Comparison Between DLD-STFC and MIMO-LDC-OFDM

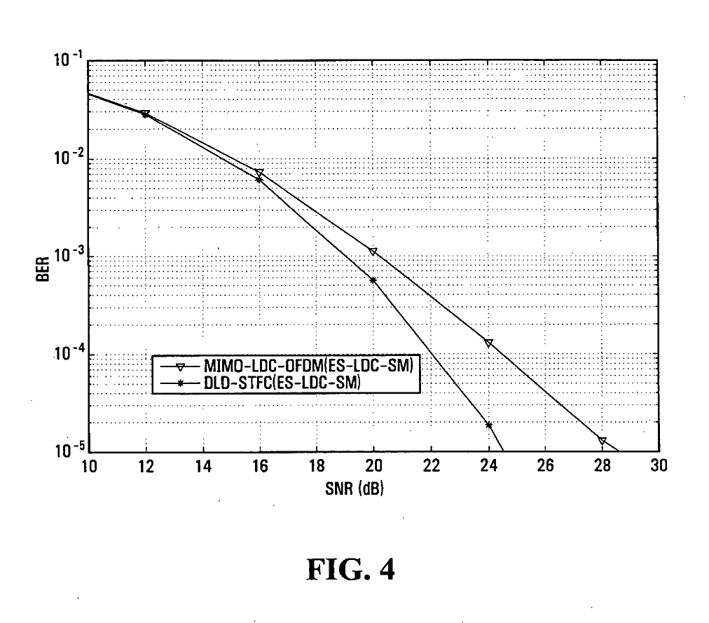

FIG. 4 compares DLD-STFC to MIMO-LDC-OFDM with same sized FT-LDC codewords in a 4×4 MIMO system. While at low SNRs, the performance difference between DLD-STFC and MIMO-LDC-OFDM is small, at high SNRs, DLD-STF noticeably outperforms MIMO-LDC-OFDM. The performance gain arises from the increased spatial diversity due to the ST-LDC coding stage of DLD-STFC.

F. Performance Comparison Between DLD-STFC and LD-STFC

We compare space and frequency diversity of DLD-STFC with ES-LDC-SM and LD-STFC with ES-LDC-SM in a 2×2 MIMO system, and remove the effects of time diversity in the channels through setting CCR to be a multiple of T.

1) Effects of Size of Subcarrier Group of DLD-STFC and LD-STFC:

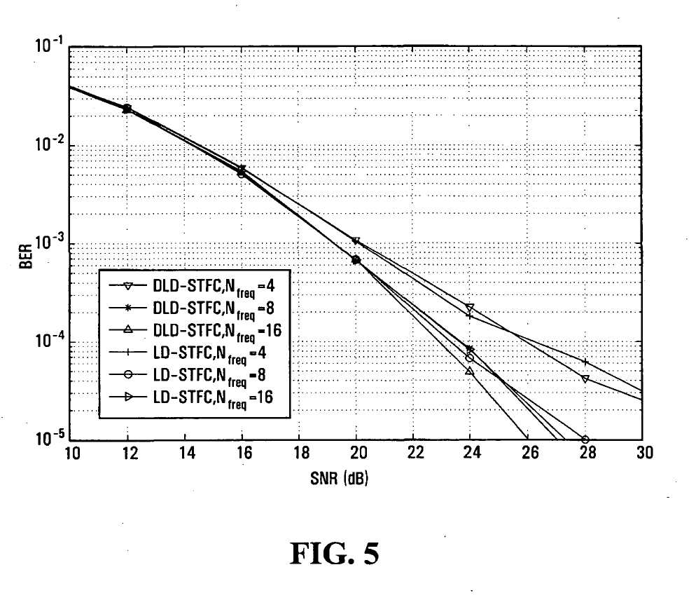

The coded STF block design with N_{F}=L+1 could achieve full frequency selective diversity, which we term a compact frequency diversity design. We investigate whether the performance of U-LDC based DLD-STFC and LD-STFC is close to compact design through comparison under different sized N_{freq} in a 2×2 MIMO system, as shown in FIG. 5. In FIG. 5, the performance of DLD-STFC and LD-STFC with N_{freq}=4=L+1 is worse than that of DLD-STFC and LD-STFC with N_{freq}=8=2(L+1) or N_{freq}=16=4(L+1), which implies N_{freq}=4=L+1 is not enough to efficiently exploit full frequency diversity in the channels. Further the performance of DLD-STFC and LD-STFC with N_{freq}=8=2(L+1) is quite close to that of DLD-STFC and LD-STFC with setting N_{freq}=16=4(L+1), which implies N_{freq}=16=4(L+1) is a saturated or over-length. The results in FIG. 5 imply that U-LDC based DLD-STFC and LD-STFC designs are not compact frequency diversity designs. Actually, according to our-simulation experiences, no matter how the system configurations are set, for example L=7 and N_{T}=N_{R}=2, to achieve maximal or saturated frequency selective diversity performance, it is necessary to set N_{freq} to at least 2(L+1).

2) Effects of STF Block Sizes of DLD-STFC and LD-STFC

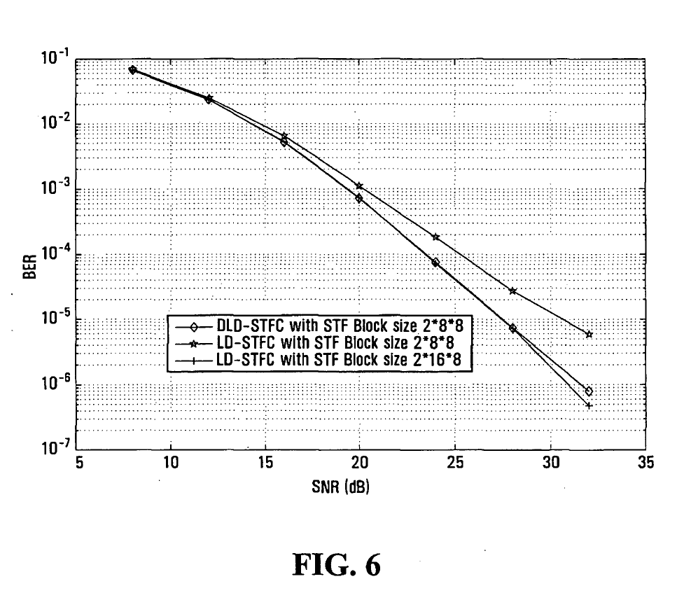

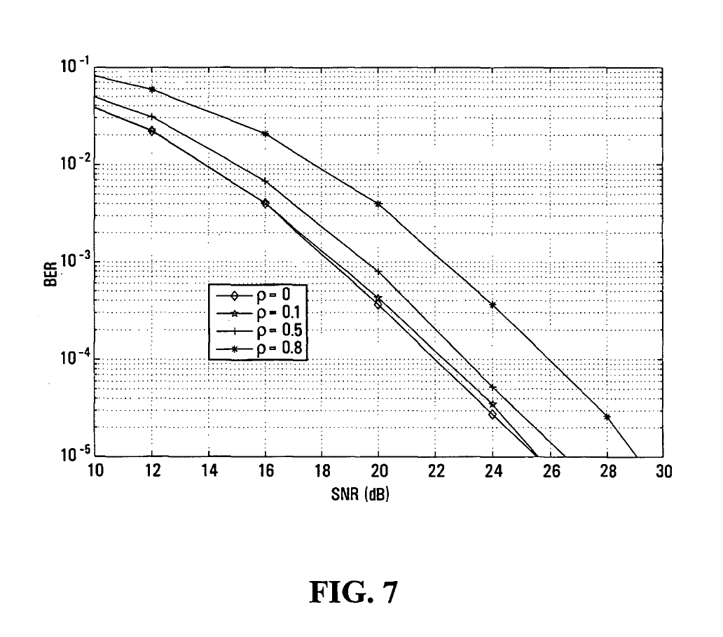

FIG. 6 compares DLD-STFC to LD-STFC with different sized N_{T}×T×N_{freq} STF blocks. In FIG. 6, DLD-STFC with STF block size 2×8×8 has performance similar to that of LD-STFC with STF block size 2×16×8, while DLD-STFC with STF block size 2×8×8 performs better than LD-STFC with STF block size 2×8×8. The reason is that the diversity order of T×M U-LDC is no larger than min {T,M} for each matrix dimension. Thus LD-STFC with STF block size 2×16×8 has the potential to achieve the same space and frequency diversity order as LD-STFC with STF block size 2×8×8.

For similar sized STF blocks, DLD-STFC utilizes smaller sized LDC codewords, thus reducing complexity.

G. Performance of DLD-STFC Under Spatial Transmit Channel Correlation

In previous parts of this section, we considered spatially uncorrelated channels. In multiple antenna systems, spatial correlation must be considered. In order to have spatially correlated frequency-selective channels, it is important to recognize that in a scenario of multi-ray delays, the gains for different delays of a channel are independent of one another [20]. Thus, the dependency between different channels comes from the correlation between tap-gains corresponding to the taps with the same delay on different spatial channels. FIG. 7 shows the performance of DLD-STFC with ES-LDC-SM under different spatial transmit channel correlation in a two transmit and two receive antenna system. In the simulations spatial correlation is assumed between transmit antennas (correlation coefficient is denoted by ρ) and not between receive antennas.

As observed in FIG. 7, spatial transmit correlation indeed degrades DLD-STFC performance. When the correlation is small, e.g., ρ=0.1, compared with the spatially uncorrelated case, the performance loss is small. At a BER of 10⁻³, the performance degrades only 0.2 dB. However, when the correlation is larger, e.g. ρ=0.5 and ρ=0.8 cases, compared with the spatially uncorrelated case, the performance loss is significant. At a BER of 10⁻³, the performance degrades by 1.3 dB and 4.0 dB, respectively. Thus spatial correlation, as expected, may notably affect diversity gain behavior of DLD-STFC when correlation is high.

System Descriptions

The above discussion has presented two detailed examples of LD code based methods/systems for use in MIMO OFDM. These examples are subject to further generalization, both in their application, and in the description that follows.

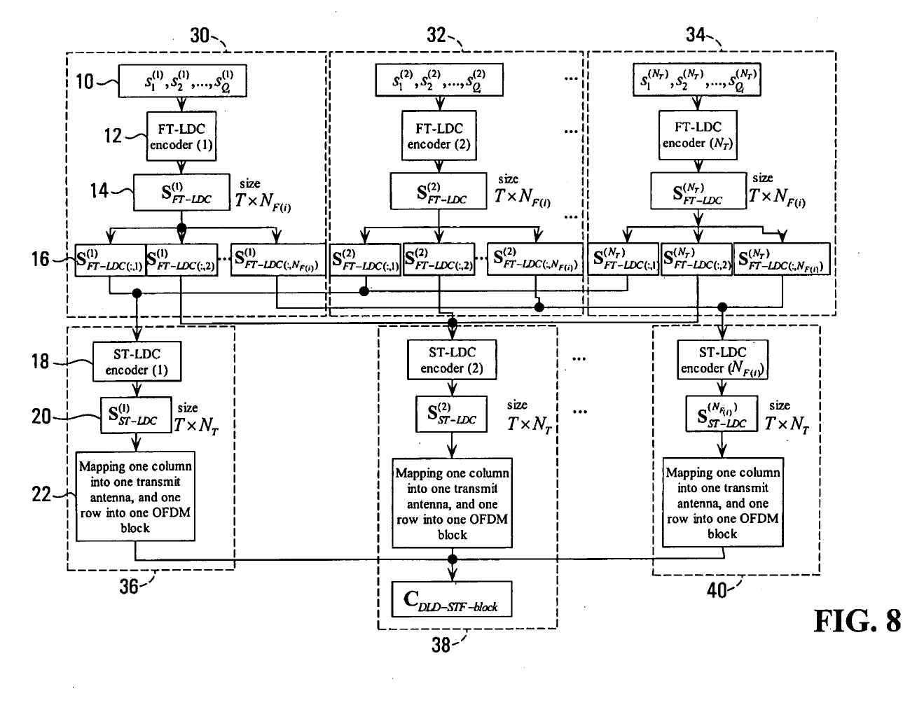

Referring now to FIG. 8, shown as a block diagram of an example DLD-encoder. There are several encoding operations grouped together at 30, 32, 34 for each transmit antenna. More generally, functionality shown for each antenna can be thought of as being associated with each transmitter output of a set of transmitter outputs. There is also a functionality grouped together at 36, 38, 40 that is in respect of each OFDM sub-carrier of a set of sub-carriers. More generally, this can be thought of as functionality for a respective carrier frequency in a multi-carrier system.

The functionality of FIG. 8, and the figures described below can be implemented using any suitable technology, for example one or a combination of software, hardware such as ASICs, FPGAs, microprocessors, etc., firmware. The transmitter outputs may be antennas as discussed in the detailed examples. More generally, any transmitter outputs are contemplated. Other examples include wire line outputs, optical fiber outputs etc.

Furthermore, while the block diagrams show a respective instance of each function each time it is required (for example FT-LDC encoder for each antenna), in some embodiments, fewer instances are physically implemented. The smaller number of physical implementations perform the larger number of functional implementations sequentially within the required processing interval.

The functionality 30 for a single antenna will now be described by way of example. A set of input symbols 10 is encoded with a FT-LDC encoder 12 to produce a two-dimensional matrix output at 14. The size of that matrix is equal to T (the number of transmit durations over which the encoding is taken place)×N_{F(i)} (the number of sub-carriers or more generally carrier frequencies in the multi-carrier system). In a preferred embodiment, the entire arrangement of FIG. 8 is replicated for each of a plurality of subsets of an overall set of OFDM sub-carriers in which case the index i refers to each subset, or for subsets of carriers in a multi-carrier system. However, in another implementation, it is possible to implement a single instance of FIG. 8 for all the sub-carriers or carrier frequencies of interest. The columns of two-dimensional matrix 14 are indicated at 16, with one column per sub-carrier frequency.

For each sub-carrier frequency, the two-dimensional matrix produced for each antenna has a respective column for that frequency. The columns that relate to the same sub-carrier frequency are grouped together and input to the respective functionality for that sub-carrier frequency. For example, the first column of each of the two-dimensional matrices output by the FT-LDC encoders are combined and input to the functionality 36 for the first sub-carrier frequency. Functionality 36 for the first sub-carrier frequency will now be described by way of example with the functionality being the same for other sub-carrier frequencies. This consists of ST-LDC encoder 18 that produces a two-dimensional matrix 20 of size T×N_{T} (where N_{T} is the number of transmit antennas or more generally transmitter outputs). For OFDM implementations, the matrix 20 is then mapped to antennas over T transmit durations by mapping one column into each transmit antenna and one row into each OFDM block (transmit duration). For OFDM implementations, an IFFT (inverse fast fourier transform) or similar function is used to map symbols to orthogonal OFDM sub-carriers.

In the above embodiment, the encoding operations 12 and 18 are frequency time-LDC and space time-LDC encoding operations respectively. More generally, one or both of these can be any vector to matrix encoding operations, with LDC encoding operations being a specific example of this.

Furthermore, the particular sequence of events in FIG. 8 shows frequency time-LDC encoding (more generally frequency-time vector to matrix encoding) followed by space time LDC encoding (more generally space time in respect to the matrix encoding). The order of these operations can be changed such that the space time encoding operation precedes the frequency time encoding operation. Furthermore, thinking of the three dimensions of frequency, time and space, the particular pairs of dimensions selected for the two vector to matrix encoding operations can be modified. An exhaustive list of permutations is:

encoding in a) space-time dimensions and b) time-frequency dimensions or vice versa;

encoding in a) time-space dimensions and b) space-frequency dimensions or vice versa; and

encoding in a) space-frequency dimensions and b) space-time dimensions;

encoding in a) space-frequency dimensions and b) frequency-time dimensions or vice versa.

In the above described implementation, it is assumed that a column of the output of the first LDC encoding operation maps to a respective sub-carrier and that a column of the output of the second LDC encoding operation maps to an antenna. It has been understood that columns or rows may map to such functions depending upon the way the matrix's are defined.

Preferably in the generalized embodiment described above, the two vector to matrix encoding operations both have rates of at least 0.5. This is simply a constraint on the selection of the codes that are implemented. The rate for this purpose is simply the ratio of the number of symbols input to the given vector to matrix encoding operation to the number of elements in the matrix output by the vector to matrix encoding operation. In a particular embodiment, the codes are selected to yield rate 1. The detailed examples presented earlier yield rate 1.

In another preferred embodiment, where there are M×N×T dimensional in space frequency and time, the first and second vector to matrix encoding operations are selected such that an overall symbol coding rate R is larger than

$$\frac{1}{min \{ M , N , T \}} .$$

Preferably each vector to matrix encoding operation produces a matrix of uncorrelated outputs meaning any output of the matrix is uncorrelated with any other element of the matrix. This of course assumes that the original inputs where uncorrelated.

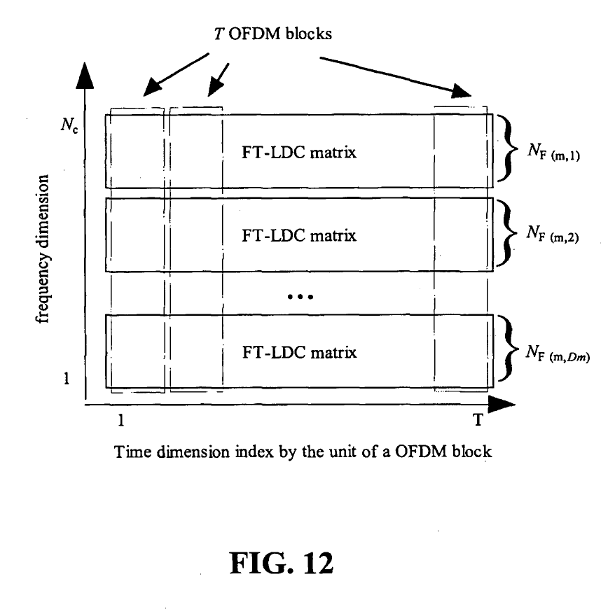

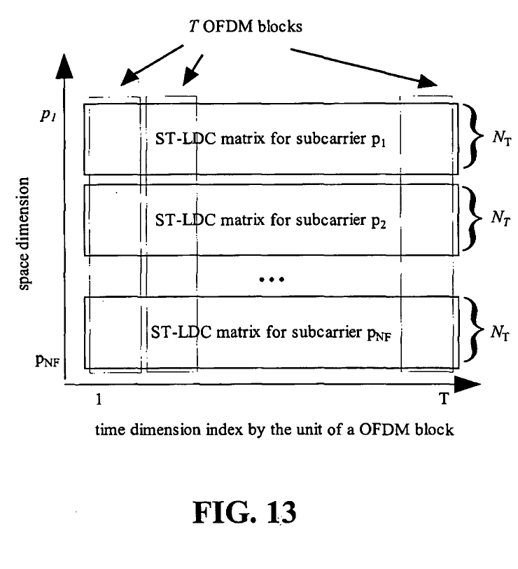

FIGS. 12 and 13 show the outputs in frequency and space of the arrangement of FIG. 8.

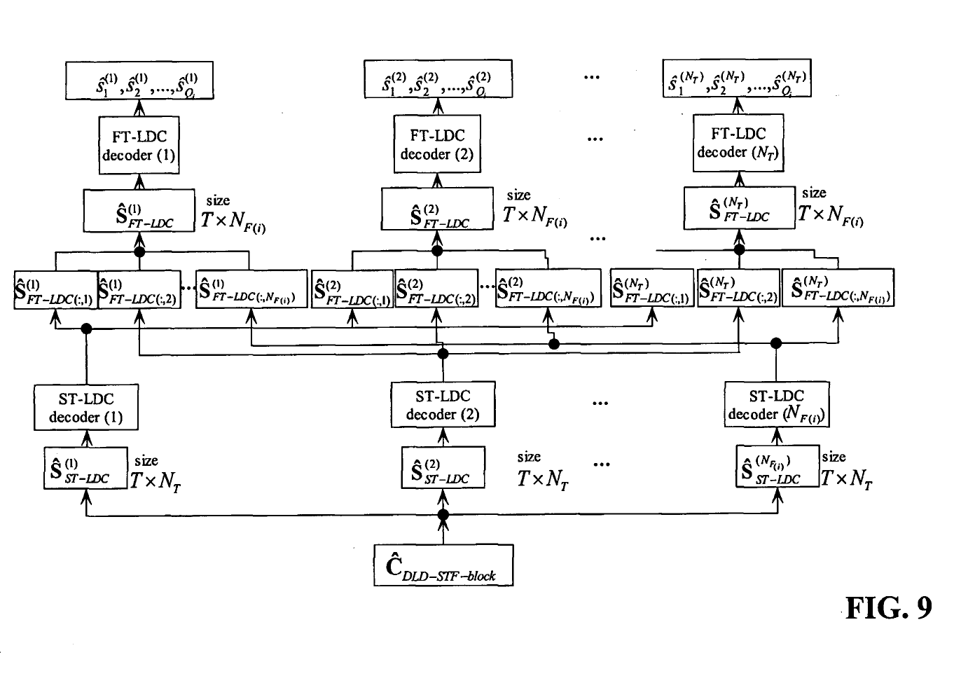

A corresponding decoder design is illustrated in FIG. 9. The appropriate generalizations can also be made in FIG. 9 corresponding to those discussed above with respect to FIG. 8, namely that the decoders may be LDC encoders, but more generally that they may be vector to matrix decoder; the entire arrangement of FIG. 9 can be repeated for multiple sub-carrier frequencies or frequencies of a multi-carrier system, or a single instance of the system can be implemented; the order of the decoding operations of course needs to parallel and be the reverse of the encoding operations of FIG. 8.

In FIG. 9, a “layered” decoding approach is used wherein a first LDC decoding operation is completely performed prior to performing a second LDC encoding operation. This is possible assuming that the encoding operations at the transmitter produced uncorrelated symbols.

In terms of complexity, implementing a two stage LDC encoder such as described in FIG. 8 is less complex than implementing a much larger single stage encoding operation. Furthermore, the complexity is also reduced by repeating the functionality of FIG. 8 for each subset of an overall set of sub-carriers. The same can be said for the decoding operations of FIG. 9. The complexity is greatly reduced if the decoding can take place in two layers. The layered view of the system is shown in FIG. 1, described earlier.

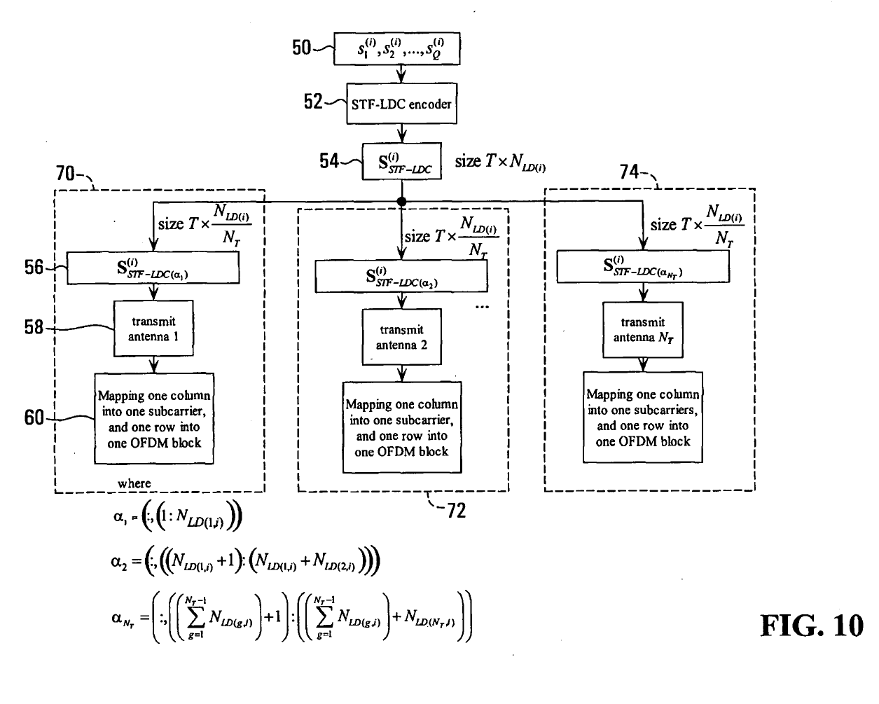

Referring now to FIG. 10, shown as a block diagram of a system for implementing the LD encoding operation described above. A set of input symbols 50 is encoding with a STF-LDC encoder to produce a two-dimensional matrix 54. Per-antenna functionality is indicated at 70, 72, 74. Functionality 70 for one antenna will now be described by way of example. The matrix is partitioned into a set of matrix's 56, these consisting of one per transmit antenna 58. Then, the matrix is mapped with one column into one sub-carrier and one row into one OFDM block at 60. Similar functionality is implemented for the other antennas. In this embodiment, there is only a single linear dispersion encoding operation and the output of that encoding operation gets distributed over the three dimensions of space time and frequency. Preferably, the arrangement of FIG. 10 is implemented for each sub set of an overall set of OFDM sub-carriers. More generally, the arrangement can be implemented for a set of carriers in a multi-carrier system, or for each subset of an overall set of carriers in a multi-carrier system. Furthermore, in the illustrated example each of the outputs of the transmitter is a respective antenna output. More generally, the spatial dimension can be considered simply to be different outputs of a transmitter, whatever they might be.

The layered structure for the single LD encoding implementation is shown in FIG. 11 for the MIMO-OFDM case.

A specific partitioning approach has been described with reference to FIG. 10. More generally, the system/method can be implemented to perform a linear dispersion encoding operation upon a plurality of input symbols to produce a two dimensional matrix output. The two dimensional matrix output can then be partitioned into matrices for time, space or frequency dimensions, these being defined by how the matrices are transmitted. For example, each matrix partition can be transmitted during a respective transmit duration in which case the matrix partition maps to multiple frequencies and multiple transmitter outputs. Each matrix partition can be transmitted on a respective frequency in which case the matrix partition maps to multiple transmit durations and multiple transmitter outputs. Finally, each matrix partition can be transmitted on a respective transmitter output in which case the matrix partition maps to multiple frequencies and multiple transmit durations.

Flexible Block Sizes

Conventional applications of LD codes have employed LD block sizes that are square or that have a column size that is a multiple of the row size.

Both DLD-STFC and LD-STFC are STFC size flexible, since both DLD-STFC and LD-STFC are STF block based. For example, in the OFDM implementation in which DLD is applied over sub-sets of sub-carriers, each DLD-STFC includes D STF block, each of which is of size T×N_{freq(i)}×N_{T} respectively, where i=1, . . . ,D.

In some embodiments, LD codes are employed that have block sizes other than a) square b) having a column size that is a multiple of the row size.

Since the size of STF block could be considered as a benchmark of the complexity of STFC. For practical systems, each STF block may belong to different users or applications, thus each STF block may have different complexity and/or throughput requirements. In some embodiments, N_{freq(i)} is selected differently for different STF blocks. Although some of them with smaller N_{freq(i)} may exploit less frequency diversity, these blocks may enjoy less complexity.

Note that the T and N_{T} of the designed STFC system is also flexible. In preferred implementations, T is chosen to satisfy
T≧max {N_{freq(i)}, N_{T}}
Capacity Optimality

High rate implementations are possible as detailed above. In other embodiments, the LD code/codes are selected to yield an overall design that is capacity optimal. By capacity optimal, it is meant that the system achieves all the capacity available in the STF channel.

Diversity

The particular LD codes employed in the detailed examples have full diversity under the condition of single symbol errors in the channel. Statistically speaking, when errors occur, single symbol errors have the highest probability. This implies fully diverse operation most of the time. The actual diversity realized by a given implementation will be implementation specific, and may be less than full diversity, even in the condition of single symbol errors in the channel. However, a preferred feature of the codes selected is that they have full diversity under this condition.

Numerous modifications and variations of the present invention are possible in light of the above teachings. It is therefore to be understood that within the scope of the appended claims, the invention may be practiced otherwise than as specifically described herein.

The following references are provided in respect of the above section.
[1] V. Tarokh, N. Seshadri, and A. Calderbank, “Space-time codes for high data rate wireless communications: performance criterion and code construction,” IEEE Trans. Inform. Theory, vol. 44, pp. 744-765, March 1998.
[2] H. Bolcskei and A. J. Paulraj, “Space-frequency coded broadband OFDM systems,” in Proc. IEEE WCNC 2000, vol. 1, 2000, pp. 1-6.
[3] Z. Liu and G. B. Giannakis, “Space-time-frequency coded OFDM over frequency-selective fading channels,” IEEE Trans. on Sig. Proc., vol. 50, no. 10, pp. 2465-2476, October 2002.
[4] S. Alamouti, “A simple transmitter diversity scheme for wireless communications,” IEEE J. Select. Areas Commun., pp. 1451-1458, October 1998.
[5] V. Tarokh, H. Jafarkhani, and A. R. Calderbank, “Space-time block code from orthogonal designs,” IEEE Trans. Inform. Theory, vol. 45, pp. 1456-1467, July 1999.
[6] Y. Xin, Z. Wang, and G. B. Giannakis, “Space-time diversity systems based on linear constellation preceding,” IEEE Trans. on Wireless Commun., vol. 2, pp. 294-309, March 2003.
[7] Y. Gong and K. B. Letaief, “Space-frequency-time coded OFDM for broadband wireless communications,” in Proc. IEEE GLOBECOM 2001, vol. 1, November 2001, pp. 519-523.
[8] W. Luo and S. Wu, “Space-time-frequency block coding over rayleigh fading channels for OFDM systems,” in Proc. Int'l Conf. on Commun. Tech., vol. 2, April 2003, p. 1012.
[9] W. Su, Z. Safar, and K. J. R. Liu, “Towards maximum achievable diversity in space, time, and frequency: performance analysis and code design 128,” IEEE Trans. on Wireless Commun., vol. 4, no. 4, pp. 1847-1857, July 2005.
[10] B. Hassibi and B. M. Hochwald, “High-rate codes that are linear in space and time,” IEEE Trans. Inform. Theory, vol. 48, no. 7, pp. 1804-1824, July 2002.
[11] R. W. Heath Jr and A. J. Paulraj, “Linear dispersion codes for MIMO systems based on frame theory,” IEEE Trans. on Sig. Proc., vol. 50, no. 10, pp. 2429-2441, October 2002.
[12] Y. Li, P. H. W. Fung, Y. Wu, and S. Sun, “Performance analysis of MIMO system with serial concatenated bit-interleaved coded modulation and linear dispersion code,” in Proc. IEEE ICC 2004, vol. 2, Paris, France, June 2004, pp. 692-696.
[13] J. Wu and S. D. Blostein, “Linear dispersion over time and frequency,” in Proc. IEEE ICC 2004, vol. 1, June 2004, pp. 254-258.
[14] W. Su, Z. Safar, and K. J. R. Liu, “Diversity analysis of space-time-frequency coded broadband OFDM systems,” in Proc. European Wireless 2004, February 2004.
[15] S. Siwamogsatham, M. P. Fitz, and J. H. Grimm, “A new view of performance analysis of transmit diversity schemes in correlated Rayleigh fading,” IEEE Trans. Inform. Theory, vol. 48, no. 4, pp. 950-956, April 2002.
[16] Z. Liu, Y. Xin, and G. B. Giannakis, “Linear constellation precoded OFDM with maximum multipath diversity and coding gains,” IEEE Trans. Commun., vol. 51, no. 3, pp. 416-427, March 2003.
[17] S. Sandhu and A. Paulraj, “Union bound on error probability of linear space-time block codes,” in Proc. IEEE ICASSP 2001, vol. 4, May 2001, pp. 2473-2476.
[18] J. Proakis, Digital communications, 3rd ed. McGraw-Hill, 2000.
[19] J. Wu and S. D. Blostein, “Rectangular full rate linear dispersion codes,” IPCL Technical Report 502. Available at http://ipcl.ee.queensu.ca/PAPERS/502/report.pdf, February 2005.
[20] G. Durgin, Space-Time Wireless Channels. Prentice Hall, 2003.
   Improved High-Rate Space-Time-Frequency Block Codes

Double linear dispersion space-time-frequency-coding (DLD-STFC) is a class of two-stage STFBCs across N_{T} transmit antennas, N_{C} subcarriers, and T OFDM blocks. DLD-STFC systems are based on a layered communications structure, which is compatible to non-LDC coded MIMO-OFDM systems. An advantage of DLD-STFC is that the system may obtain 3-D diversity performance for the source data symbols that are only encoded and decoded through 2-D coding, and the complexity advantage may be significant if non-linear decoding methods, e.g. sphere decoding, are involved. In this section, the diversity properties of DLD-STFC are improved through investigating the relationship of the two stages of 2-D CDC of DLD-STFC. The above described DLD-STFC is now referred to as DLD-STFC Type A, which firstly encodes frequency-time LDC (FT-LDC) and secondly encodes space-time LDC (ST-LDC). By exchanging the sequence of the two stages, a modified version of DLD-STFC, termed as DLD-STFC Type B, is provided as follows. The first CDC encoding stage is the ST-LDC, performed across space (transmit antennas) and time (OFDM blocks), enabling space and time diversity. The second CDC encoding stage is the FT-LDC, performed across frequency (subcarriers) and time (OFDM blocks), enabling frequency and time diversity. The corresponding encoding procedure for the i-th STF block of size T×N_{F}×N_{T} within one DLD-STFC Type B block is that:

1) Firstly, the source data signals are encoded through per subcarrier ST-LDC. The p-th ST matrix codeword is of size T×N_{T}, where p=p₁₍ᵢ₎,p₂₍ᵢ₎, . . . , p_{N}_{_{F(i)}} are subcarrier indices.

2) Secondly, all the m-th space index columns of N_{F(i)} ST-LDC codewords are concatenated in sequence to a vector of size TN_{F(i)}×1, which is further encoded into the m-th FT-LDC codeword of the i-th STF block. The m-th FT-LDC matrix codeword is of size T×N_{F(i)}. After N_{T} FT-LDC matrix codewords are created, the i-th STF block is created.

If all subcarriers are used for DLD-STFC and there are in total N_{M} STF blocks within one DLD-STFC Type B block, the frequency block size relation is

$${N}_{C} = {\sum }_{i = 1}^{{N}_{M}} {N}_{F ( i )} .$$

The decoding sequence of DLD-STFC Type B is in the reverse order of the encoding procedure.

Note that it is inconvenient to analyze the diversity order of DLD-STFC in general due to the two stages involved. For further analysis, we employ Tirkkonen and Hottinen' concept of symbol-wise diversity order for 2-D codes with dimensions X and Y, O. Tirkkonen and A. Hottinen, “Maximal Symbolwise Diversity in Non-Orthogonal Space-Time Block Codes”, in Proc. IEEE Int'l Symposium on Inform. Theo, ISIT 2001, June 2001, pp. 197-197; “Improved MIMO Performance with Non-Orthogonal Space-time Block Codes,” in Proc. IEEE Globecom 2001, vol. 2, November 2001, pp. 1122-1126. This concept is extended by introducing a new term, K-symbol-wise diversity order for 2-D codes, for the case that the pair of matrix codewords contain at most K symbol differences, and

$${r}_{d ( XY )}^{( K )} = min \{ \begin{matrix}rank ( {Φ}_{{q}_{1} , … , {q}_{K}} ) , 1 \leq {q}_{i} \leq Q , \\ {q}_{i} \neq {q}_{k} , 1 \leq \{ i , k \} \leq K\end{matrix} \} , where$$

$${Φ}_{{q}_{1} , … , {q}_{K}} = {A}_{{q}_{1}} ( {s}_{{q}_{1}} - {\tilde{s}}_{{q}_{1}} ) + … + {A}_{{q}_{K}} ( {s}_{{q}_{K}} - {\tilde{s}}_{{q}_{K}} ) , \qquad {A}_{q} , q = 1 , … , Q ,$$

are dispersion matrices, and {s_{q1}, . . . ,s_{qk},} and {\tilde{s}_{q1}, . . . ,\tilde{s}_{qk}} are a pair of different source symbol sequences with at least one symbol difference. Note that r_{sd(ZY)}=r_{d(XY)}⁽ⁱ⁾.

Further, two new concepts of 3-D codes are introduced: per dimension diversity order and per dimension symbol-wise diversity order. Symbol-wise diversity order is a subset of full diversity order. The importance of symbol-wise diversity for 2-D codes has been explained in the Tirkkonen and Hottinen references identified above, and based on similar reasoning, full symbol-wise diversity for 3-D codes is also important, especially in high SNR regions.

Definition

A pair of 3-D coded blocks M and \tilde{M} in dimensions X, Y, and Z are of size N_{X}×N_{Y}×N_{Z}. All possible M and \tilde{M} comprise the set [symbol] . Denote

$${M}_{( a )}^{( XZ )} and {\tilde{M}}_{( a )}^{( XZ )}$$

as a pair of X-Z blocks corresponding to the a-th Y dimension of size N_{X}×N_{Z} within M and \tilde{M}, respectively. All possible

$${M}_{( a )}^{( XZ )} and {\tilde{M}}_{( a )}^{( XZ )}$$

comprise the set

$${M}_{( a )}^{( XZ )} .$$

Denote

$${M}_{( b )}^{( YZ )} and {\tilde{M}}_{( b )}^{( XZ )}$$

as a pair of Y-Z blocks corresponding to the b-th X dimension of size N_{Y}×N_{Z} within M and \tilde{M}, respectively. All possible

$${M}_{( a )}^{( XY )} and {\tilde{M}}_{( a )}^{( XZ )}$$

comprise the set

$${M}_{( a )}^{( XY )} .$$

Denote per dimension diversity order of Y as r_{d(Y)}, which is defined as
r_{d(Y)}=max {r_{d(XY)},r_{d(ZY)}}
where

$${r}_{d ( XY )} = min \{ \begin{matrix}rank ( {M}_{( a )}^{( XY )} - {\tilde{M}}_{( a )}^{( XY )} ) , \\ a = 1 , … , {N}_{Z} , \\ {M}_{( a )}^{( XY )} ∈ {ℳ}_{( a )}^{( XY )} , \\ {\tilde{M}}_{( a )}^{( XY )} ∈ {ℳ}_{( a )}^{( XY )} , \\ {M}_{( a )}^{( XY )} \neq {\tilde{M}}_{( a )}^{( XY )} , \\ {M}_{( a )}^{( XY )} within M \\ {\tilde{M}}_{( a )}^{( XY )} within \tilde{M} \\ M ∈ ℳ , \tilde{M} ∈ ℳ , \\ M \neq \tilde{M}\end{matrix} \}$$

r_{d(ZY)} is defined similarly to r_{d(XY)}.
Definition

For a 3-D code, the definition of the per dimension symbol-wise diversity order of Y is the same as that of the per dimension diversity order of Y except that it is required that the pair of M and \tilde{M} is different only due to a single source symbol difference, which is denoted as [M≠\tilde{M}]_{sw}. Denote per dimension symbol-wise diversity order of Y as r_{sd(Y)}, which is defined as
r_{d(Y)}=max {r_{sd(XY)},r_{d(ZY)},}
where r_{sd(XY)} and r_{sd(ZY)} are as in Definition of r_{d(XY)} and r_{d(ZY)}, except that [M≠\tilde{M}]_{sw} instead of M≠\tilde{M}.

The above two concepts quantify the fact that in the case of N_{X}<N_{Y}≦N_{Z}, the dimension Y may reach full per dimension (symbol-wise) diversity order N_{Y} in the Y-Z plane, although Y cannot reach full per dimension (symbol-wise) diversity order in the X-Y plane.

Definition

A 3-D code is called full symbol-wise diversity code if the per dimension symbol-wise diversity orders of X, Y, and Z satisfy
r_{sd(X)}=N_{X},
r_{sd(Y)}=N_{Y},
and
r_{sd(Z)}=N_{Z}.

Note that a full symbol-wise diversity code is achievable only if at least the two largest of N_{X}, N_{Y}, and N_{Z} are equal.

It can be shown that a properly designed DLD-STFC may achieve full symbol-wise diversity. Let the time dimension be of size T, and space and frequency dimensions be of size either N_{X} and N_{Y}, respectively, or, N_{Y} and N_{X}, respectively. Without loss of generality, say that dimension X is of size N_{X}, and dimension Y is of size N_{Y}. One STF block of size N_{X}×N_{Y}×T is constructed through a double linear dispersion (DLD) encoding procedure such that the first LDC encoding stage constructs LDCs of size T×N_{X} in the X-time planes, and the second LDC encoding stage constructs LDCs of size T×N_{Y} in the Y-time planes.

Proposition

Assume that a DLD procedure is with the above notations. Assume that the second LDC encoding stage produces asymptotically information lossless or rate-one codewords. Assume that all-zero data source elements are allowed for DLD encoding.

In the case of N_{X}<N_{Y}=T, if each of the two stage LDC encoding procedure enables full diversity in their 2-dimensions, the per dimension diversity orders of Y and time dimensions satisfy
r_{d(Time)}=r_{d(Y)}=T=N_{Y}

Assume that the following conditions are satisfied:

a) Each block of Q source data symbols are encoded into each first stage LDC codeword. The first stage LDC encoding procedure enables full symbol-wise diversity in its 2-dimensions, and the second stage LDC encoding procedure enables full K-symbol-wise diversity in its 2-dimensions, where K is the maximum number of non-zero symbols of all the n_{X}-th time dimensions after the first stage LDC encoding procedure, where n_{X}=1, . . . , N_{X}.

b) All the encoding matrices of the second stage LDCs are the same. Denote the dispersion matrices of the second stage LDC as A_{q}⁽²⁾, where q=1, . . . ,N_{Y}T. Denote

$${J}_{( a , b )} = [ {[ {A}_{( a - 1 ) T + 1}^{( 2 )} ]}_{: , b} , … , {[ {A}_{aT}^{( 2 )} ]}_{: , b} ] ,$$

where a=1, . . . ,N_{Y} and b=1, . . . ,N_{Y}. Square matrix J_{(a,b)} is full rank, i.e. invertible, for any a=1, . . . ,N_{Y} and b=1, . . . , N_{Y}.

In the cases of both N_{X}<N_{Y}=T and N_{X}=T>N_{Y}, the STF block, constructed using DLD procedure, achieves full symbol-wise diversity order.

The above Proposition provides a sufficient condition for full symbol-wise diversity. The condition (b) is referred to herein as the DLD cooperation criterion (DLDCC). When failing to meeting DLDCC, full symbol-wise diversity cannot be guaranteed. Due to the support of DLDCC, the complex diversity coding design in the second LDC stage is more restrictive than that in the first LDC stage.

According to the above Proposition, the sequence of ST-LDC and FT-LDC stages can be inter-changed. Properly designed, both DLD-STFC Type A and DLD-STFC Type B are able to achieve full symbol-wise diversity.

Complex Diversity Coding Based STFC with FEC

The fundamental differences between complex diversity coding (CDC) and FEC is that CDC improves performance through obtaining better effective communication channels for source data signals while channel codes improve performance through correcting errors; CDC operates in the (approximately) continuous (in the case of using limited accuracy float-point DSP chips) or multi-level-discrete-valued (in the case of using limited accuracy fixed-point DSP chips) domain, while FEC operates in the discrete-valued domain. In some embodiments, FEC is employed in cooperation with complex diversity coding to achieve better performance. A practical issue is the amount of gain that can be obtained by combining CDC based STFC and FEC.

Due to the multidimensional structure, there are many possible mappings from FEC to STFC, which might influence system performance. Reed Solomon (RS) codes are the chosen FEC for the examples described. The reasons to consider RS codes are listed below. Certainly, other FEC, such as turbo codes, also may be applied. The usage of RS codes is a proof of concept.

RS codes are block codes with strong burst error correction ability. If the RS symbols are distributed over different CDC codewords, the burst error correction ability may be efficiently used, since the burst errors may take place within one CDC codeword. RS codes are block based and CDC are also block based, thus the mapping from RS codes to CDCs are convenient. Block codes usually have lower latency than convolutional codes.

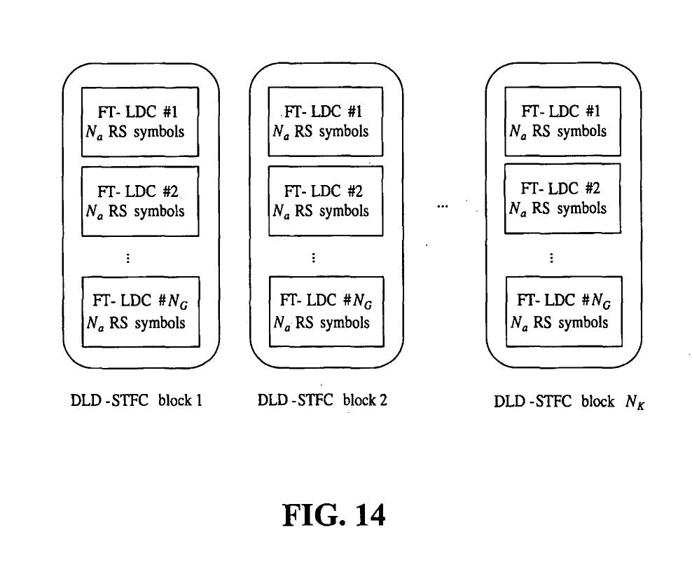

In the next section, RS(a,b,c) denotes RS codes with a coded RS symbols, b information RS symbols, and c bits per symbol. As shown in FIG. 14, one RS(a,b,c) codeword is mapped to N_{K} DLD-STFC blocks, and NₐRS symbols are mapped into each of N_{G} FT-LDC codewords within each DLD-STFC block, where a=NₐN_{G}N_{K}. In the case of N_{K}>1, the method is referred to herein as inter-CDC-STFC FEC, while in the case of N_{K}=1, the method is referred to herein as intra-CDC-STFC FEC.

Performance

Perfect channel knowledge (amplitude and phase) is assumed at the receiver but not at the transmitter. The symbol coding rates of all systems are unity. The sizes of all LDC codewords in the ST-LDC and FT-LDC stage of DLD-STFC are T×N_{T} and T×N_{F}, respectively. An evenly spaced LDC subcarrier mapping for the FT-LDC of DLD-STFC is used in simulations.

The frequency selective channel has L+1 paths exhibiting an exponential power delay profile, and a channel order of L1=3 is chosen. Data symbols use QPSK modulation in all simulations. Denote the transmit spatial correlation coefficient for 2×2 MIMO systems by ρₜ. The signal-to-noise-ratio (SNR) reported in all figures is the average symbol SNR per receive antenna.

Satisfaction of DLDCC Influences the Performance of DLD-STFC Type A and Type B

In the previous design of DLD-STFC Type A, FT-LDC and ST-LDC chose HH square code and uniform linear dispersion codes, respectively, as dispersion matrices, both of which support full symbol-wise diversity in 2-dimensions. Note that original U-LDC design does not support DLDCC, while the square design supports DLDCC. The results show that by changing index of dispersion matrices such that the sequence of the dispersion matrices {A₁, . . . ,A_{Q}} is modified as {A_{σ(1)}, . . . ,A_{σ(Q)}}, where σ is a special permutation operation, a modified U-LDC is able to support DLDCC, thus DLD-STFC Type A based on the modified U-LDC may achieve full symbol-wise diversity in 3-dimensions. Note that the only situation which the code design should consider is the case of T>M. Note that if T>M, original U-LDC is defined as

$${A}_{q} = {B}_{q} = {A}_{M ( k - 1 ) + l} = \frac{1}{\sqrt{M}} {Π}^{k - 1} Γ {D}^{l - 1} ,$$

where k=1, . . . ,T and l=1, . . . ,M. If T>M, the modified U-LDC, which supports DLDCC, is with dispersion matrices as follows,

$${A}_{q} = {B}_{q} = {A}_{T ( l - 1 ) + k} = \frac{1}{\sqrt{M}} {Π}^{k - 1} Γ {D}^{l - 1} ,$$

where k=1, . . . ,T and l=1, . . . ,M .

It is possible that the modified DLD-STFC Type A may achieve full K-symbol-wise diversity in 3-dimensions for some K>1, and the performance is close to full diversity performance in 3-dimensions.

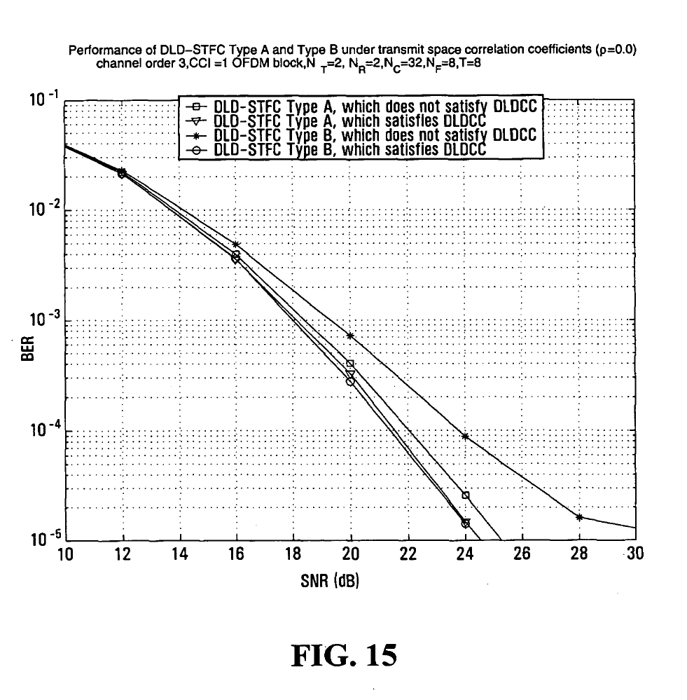

FIG. 15 shows that the performance comparison of Bit Error Rate (BER) vs. SNR between DLD-STFC Type A and DLD-STFC Type B with and without satisfaction of DLDCC. It is clear that both DLD-STFC Type A and Type B with satisfaction of DLDCC notably outperform both DLD-STFC Type A and Type B without satisfaction of DLDCC. Note that the sensitivity to DLDCC of DLD-STFC Type A is more than that of DLD-STFC Type B, which might be due to the fact that the size of frequency dimension of the codes is larger than that of space dimension of the codes. The performance of DLD-STFC Type A with satisfaction of DLDCC is quite close to that of DLD-STFC Type A with satisfaction of DLDCC. Thus DLD-STFC Type A can achieve similar high diversity performance to DLD-STFC Type B. In the rest of this section, DLD-STFC Type A with satisfaction of DLDCC is chosen.

Performance Comparison of RS Codes Based STFCs

Five RS(8,6,4) codes based STFCs are compared:

(1) the combination of DLD-STFC with RS codes with parameters Nₐ=2, N_{G}=4, and N_{K}=1;

(2) the combination of DLD-STFC with RS codes with Nₐ=1, N_{G}=2, and N_{K}=4;

(3) the combination of DLD-STFC with RS codes with Nₐ=1, N_{G}=1, and N_{K}=8;

(4) the combination of linear constellation precoding (LCP) based space-frequency codes with RS codes over T=8;

(5) OFDM blocks single RS codes across space-time-frequency.

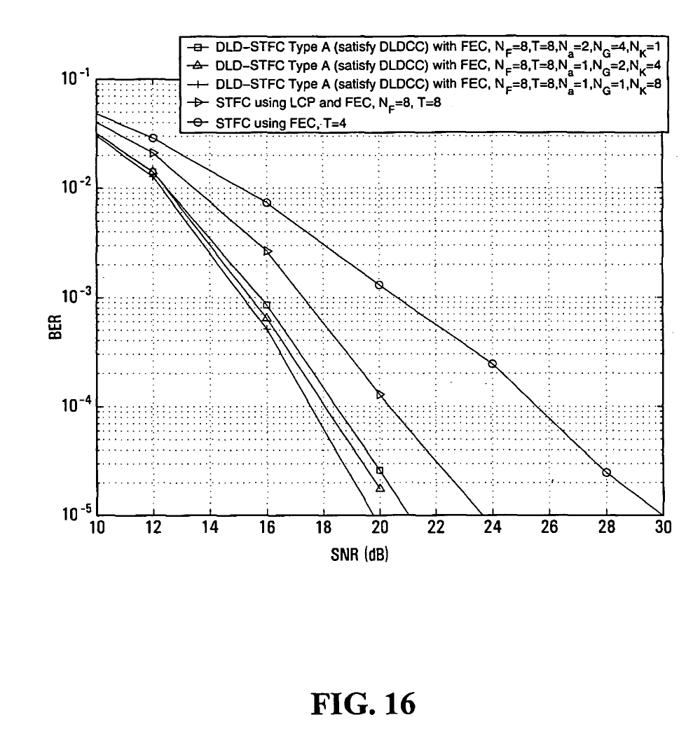

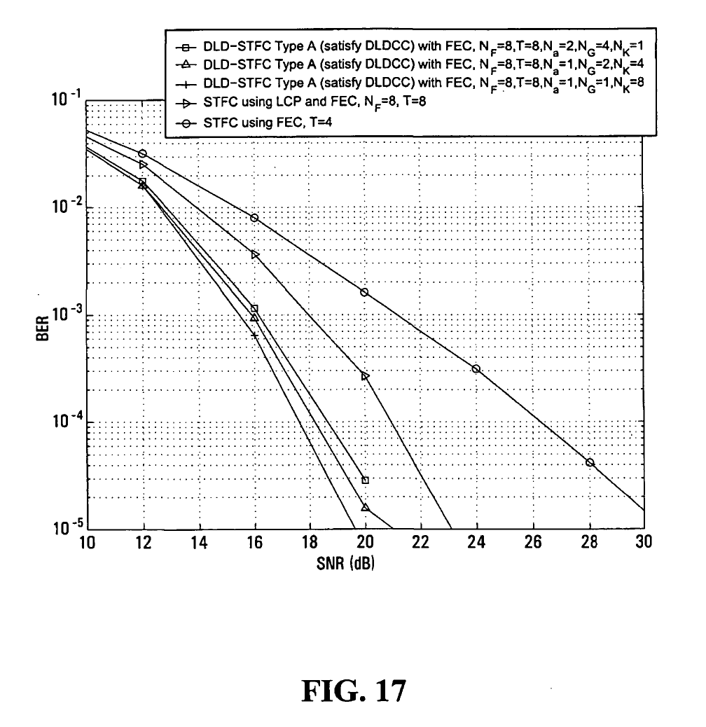

FIGS. 16 and 17 show the performance comparison of FEC based STFCs. Note that LCP used in STFC (4) supports maximal diversity gain and coding gains in supported dimensions. It can observed that using the same FEC, STFCs (1), (2), and (3) significantly outperform STFCs (4) and (5) under transmit spatial correlation ρₜ=0 and ρₜ=0.3, respectively. Thus, STFCs based on the combination of DLD-STFC and FEC may be the best choices in terms of BER performance.

Note that the performance advantage of STFCs (1), (2), and (3) over STFCs (4) and (5) appears more significant with an increase of transmit spatial correlation. According to FIGS. 16 and 17, different mappings from FEC to STFC may lead to different BER performance of FEC based DLD-STFCs. Using the same block based FEC, it seems that the larger the number of STFCs that one RS codeword is across, the better the system performance of the STFCs of Category 6, and inter-CDC-STFC FEC systems outperform intra-CDC-STFC FEC ones.

### REFERENCES

The following references are provided in respect of the above section.
[1] V. Tarokh, H. Jafarkhani, and A. R. Calderbank, “Space-time block code from orthogonal designs,” IEEE Trans. Inform. Theory, vol. 45, pp. 1456-1467, July 1999.
[2] W. Su, Z. Safar, and K. J. R. Liu, “Diversity analysis of space-time modulation over time-correlated Rayleigh-fading channels,” IEEE Trans. Inform. Theory, vol. 50, no. 8, pp. 1832-1840, August 2004.
[3] K. Ishll and R. Kohno, “Space-time-frequency turbo code over time-varying and frequency-selective fading channel,” IEICE Trans. on Fundamentals of Electronics, Commun. and Computer Sciences, vol. E88-A, no. 10, pp. 2885-2895, 2005.
[4] M. Guillaud and D. T. M. Slock, “Multi-stream coding for MIMO OFDM systems with space-time-frequency spreading,” in Proc. The International Symposium on Wireless Personal Multimedia Commun., vol. 1, October 2002, pp. 120-124.
[5] J. Wu and S. D. Blostein, “High-rate codes over space, time, and frequency,” in Proc. IEEE Globecom 2005, vol. 6, November 2005, pp. 3602-3607.
[6] W. Zhang, X. G. Xia, and P. C. Ching, “High-rate full-diversity space-time-frequency codes for mimo multipath block fading channels,” in Proc. IEEE Globecom 2005, vol. III, November 2005, pp. 1587-1591.
[7] B. Hassibi and B. M. Hochwald, “High-rate codes that are linear in space and time,” IEEE Trans. Inform. Theory, vol. 48, no. 7, pp. 1804-1824, July 2002.
[8] J. Wu and S. D. Blostein, “Linear dispersion over time and frequency,” in Proc. IEEE ICC 2004, vol. 1, June 2004, pp. 254-258.
[9] O. Tirkkonen and A. Hottinen, “Maximal symbolwise diversity in nonorthogonal space-time block codes,” in Proc. IEEE Int'l Symposium on Inform. Theo, ISIT 2001, June 2001, pp. 197-197.
[10]—, “Improved MIMO performance with non-orthogonal space-time block codes,” in Proc. IEEE Globecom 2001, vol. 2, November 2001, pp. 1122-1126.
[11] J. Wu, Exploiting diversity across space, time and frequency for highrate communications. Ph.D. Thesis, Queen's University, Kingston, ON, Canada, 2006.
[12] Y. Xin, Z. Wang, and G. B. Giannakis, “Space-time diversity systems based on linear constellation preceding,” IEEE Trans. on Wireless Commun., vol. 2, pp. 294-309, March 2003.
[13] Z. Liu, Y. Xin, and G. B. Giannakis, “Linear constellation precoded OFDM with maximum multipath diversity and coding gains,” IEEE Trans. Commun., vol. 51, no. 3, pp. 416-427, March 2003.
   Space-Time Linear Dispersion Using Coordinate Interleaving

To support high reliability of space-time multiple input multiple output (MIMO) transmission, space-time coding (STC) may be applied to improve system performance and achieve high capacity potential. Space-time trellis codes [1] have great diversity and coding gain but exponential decoding complexity, which motivates the design of low complexity STC. Due to their attractive complexity, a number of block-based STC have been proposed [2] [3]. Recently, Hassibi and Hochwald have constructed a class of high-rate block-based STC known as linear dispersion codes (LDC) [4], which support arbitrary numbers of transmit and receive antenna channels. LDC IS treated herein as a general framework of complex space-time block code design.

A problem in most existing design criteria of block-based space-time codes, including LDC (which allow different dispersion matrices for real and image parts of coordinates), is that they do not efficiently exploit additional diversity potential in the real and image parts of coordinates of source data constellation symbols. A technique to utilize the diversity potential of real and image parts of coordinates is called coordinate interleaving or component interleaving (CI), which was first proposed for single transmission stream system [5] [6]. Recently, CI has been applied to multiple antennas systems [7] [8] [9]. Kim and Kaveh have combined CI-OSTBC and constellation rotation [7]. Khan, Rajan, and Lee used CI concepts to design coordinate space-time orthogonal block codes [8] [9]. However, current existing approaches to using CI in block-based space-time codes are low-rate designs using orthogonal space-time block codes or their variation [7] [8] [9].

This section provides coordinate interleaving as a general principle for high-rate block-based space-time code design, i.e., space-time coordinate interleaving linear dispersion codes (ST-CILDC). An upper bound diversity order is determined, as are statistical diversity order and average diversity order of ST-CILDC. ST-CILDC maintains the same diversity order as conventional ST-LDC. However, ST-CILDC may show either almost doubled average diversity order or extra coding advantage over conventional ST-LDC in time varying channels. Compared with conventional ST-LDC, ST-CILDC maintains the diversity performance in quasi-static block fading channels, and notably improves the diversity performance in rapid fading channels.

A. MIMO System Model for LDC in Time Varying Channels

In frequency-flat, time non-selective Rayleigh fading channels whose coefficients may vary per channel symbol time slot or channel use, a multi-antenna communication system is assumed with N_{T} transmit and N_{R} receive antennas. Assume that an uncorrelated data sequence has been modulated using complex-valued source data symbols chosen from an arbitrary, e.g. D-PSK or D-QAM, constellation. Each LDC codeword of size T×NT is transmitted during every T time channel uses from N_{T} transmit antennas.

1) Component Matrices in System Equations:

Several component matrices are introduced during the k-th space-time LDC codeword transmission.

The received signal vector

$${x}_{LDC}^{( k )} = {[ {[ {x}_{LDC}^{( k , 1 )} ]}^{T} , … , {[ {x}_{LDC}^{( k , T )} ]}^{T} ]}^{T} ,$$

where

$${x}_{LDC}^{( k , t )} ∈ {C}^{{N}_{T} \times 1} , t = 1 , … , T ,$$

is the received vector corresponding to the t-th row of the k-th LDC codeword,

$${S}_{LDC}^{( k )} .$$

The system channel matrix is

$${H}_{LDC}^{( k )} = [ \begin{matrix}{H}_{LDC}^{( k , 1 )} & ⋯ & 0 \\ ⋮ & ⋰ & ⋮ \\ 0 & ⋯ & {H}_{LDC}^{( k , T )}\end{matrix} ] ,$$

where

$${H}_{LDC}^{( k , t )} ∈ {C}^{{N}_{R} \times {N}_{T}} , t = 1 , … , T$$

with entries

$${[ {H}_{LDC}^{( k , t )} ]}_{n , m} = {h}_{n , m}^{( h , j )} , m = 1 , … {N}_{T} , n = 1 , … , {N}_{R} ,$$

is a complex Gaussian MIMO channel matrix with zero-mean, unit variance entries corresponding to the t-th row of the k-th LDC codeword,

$${S}_{LDC}^{( k )} ,$$

and 0 denotes a zero matrix of size N_{R}×N_{T}.

The complex Gaussian noise vector is

$${v}_{LDC}^{( k )} = {[ {[ {v}_{LDC}^{( k , 1 )} ]}^{T} , … , {[ {v}_{LDC}^{( k , T )} ]}^{T} ]}^{T} ,$$

where

$${v}_{LDC}^{( k , t )} ∈ {C}^{{N}_{R} \times 1} , t = 1 , … , T ,$$

is a complex Gaussian noise vector with zero mean, unit variance entries corresponding to the t-th row of the k-th LDC codeword,

$${S}_{LDC}^{( k )} .$$

The LDC encoded complex symbol vector

$${s}_{LDC}^{( k )}$$

corresponds to the k-th LDC codeword,

$${S}_{LDC}^{( k )} ,$$

where

$${s}_{LDC}^{( k )} = vec ( {[ {S}_{LDC}^{( k )} ]}^{T} ) . \qquad ( 1 )$$

System Model Equation

The system equation for the transmission of the k-th LDC matrix codeword is expressed as

$${x}_{LDC}^{( k )} = \sqrt{\frac{ρ}{{N}_{T}}} {H}_{LDC}^{( k )} {s}_{LDC}^{( k )} + {v}_{LDC}^{( k )} \qquad ( 2 )$$

where ρ is the signal-to-noise ratio (SNR) at each receive antenna, and independent of N_{T}.
B. Procedure of Space-Time Inter-LDC Coordinate Interleaving

There are a pair of source data symbol vectors s₁ and s₂ with the same number Q of source data symbol symbols, where

$${s}^{( 1 )} = {[ {s}_{1}^{( 1 )} , … , {s}_{Q}^{( 1 )} ]}^{T} , \\ \begin{matrix}{s}^{( 2 )} = {[ {s}_{1}^{( 2 )} , … , {s}_{Q}^{( 2 )} ]}^{T} \\ and \\ {s}_{q}^{( i )} = Re ( {s}_{q}^{( i )} ) + jIm ( {s}_{q}^{( i )} ) , & □\end{matrix}$$

where i=1,2,q=1, . . . ,Q. The transmitter first coordinate-interleaves s⁽¹⁾ and s⁽²⁾ into s^{CI(1)} and s^{CI(2)}, where

$${s}^{CI ( 1 )} = {[ {s}_{1}^{CI ( 1 )} , … , {s}_{Q}^{CI ( 1 )} ]}^{T} , {s}^{CI ( 2 )} = {[ {s}_{1}^{CI ( 2 )} , … , {s}_{Q}^{CI ( 2 )} ]}^{T} , \\ \begin{matrix}{s}_{q}^{CI ( 1 )} = Re ( {s}_{q}^{( 1 )} ) + jIm ( {s}_{q}^{( 2 )} ) , & ( 3 ) \\ {s}_{q}^{CI ( 2 )} = Re ( {s}_{q}^{( 2 )} ) + jIm ( {s}_{q}^{( 1 )} ) , & ( 4 )\end{matrix}$$

then encodes s^{CI(1)} and s^{CI(2)} into two LDC codewords of size

$$T \times {N}_{T} {S}_{LDC}^{CI ( 1 )} and {S}_{LDC}^{CI ( 2 )} ,$$

respectively. Then the transmitter send

$${S}_{LDC}^{CI ( 1 )} and {S}_{LDC}^{CI ( 2 )}$$

during such two interleaved periods that the space time channels statistically vary.

It is noted that using different permutations, other methods of space-time inter-LDC CI than (3) and (4) are also possible. The LDC encoding matrices for

$${S}_{LDC}^{CI ( 1 )} and {S}_{LDC}^{CI ( 2 )}$$

need not be the same.

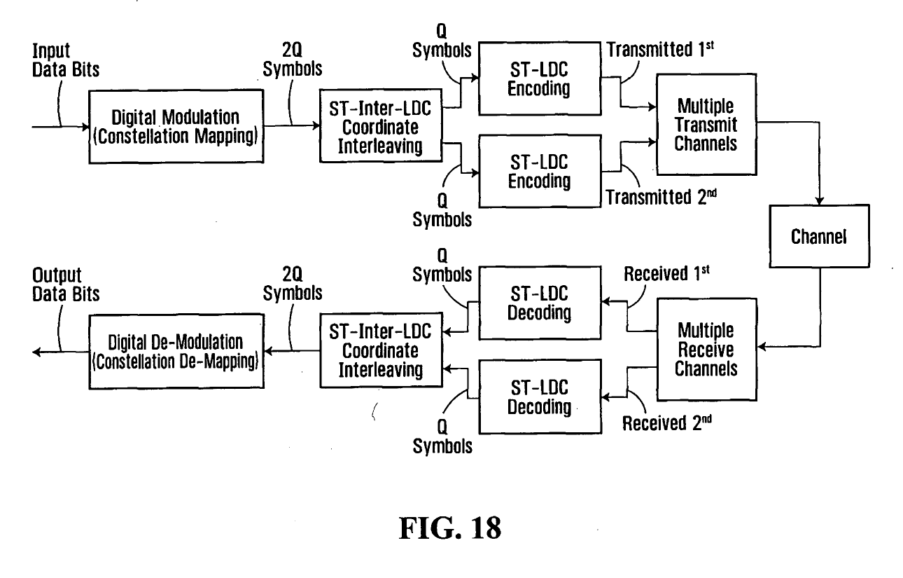

An example of the ST-CILDC system structure is shown in FIG. 18. The system structure basically consists of three layers: (1) mapping from data bits to constellation points, (2) inter-LDC coordinate interleaving, and (3) LDC coding. Using the proposed layered structure, the only additional complexity compared with a conventional ST-LDC system is the coordinate interleaving operation. Thus, ST-CILDC system is computationally efficient. The motivation of ST-CILDC is to render the fading more independent of each coordinate of the source data signals. Note that due to the superposition effects of signals from multiple transmit antennas at the space-time MIMO receivers, existing LDC designs cannot guarantee fading independence of each coordinate of the source data signals. Compared with ST-LDC, ST-CILDC introduces coordinate fading diversity at the cost of more decoding delay using a pair of LDC codewords of the same size.

Diversity Analysis

Su and Liu [10] recently analyzed the diversity of space-time modulation over time-correlated Rayleigh fading channels. A modified strategy can be used to investigate the diversity of ST-CILDC systems.

Consider a ST-CILDC block C, which consists of two ST-LDC codewords of size

$$T \times {N}_{T} , {S}_{LDC}^{CI ( 1 )} and {S}_{LDC}^{CI ( 2 )} .$$

The communication model for one ST-CILDC block C can be rewritten as

$$Y = \sqrt{\frac{ρ}{{N}_{T}}} MH + Z \qquad ( 5 )$$

where

the noise vector is Z,

the received signal vector Y=[[Y⁽¹⁾]^{T} , [Y⁽²⁾]^{T} ]^{T}, where

$${Y}^{( k )} = {[ {Y}_{1}^{( k )} , … , {Y}_{{N}_{R}}^{( k )} ]}^{T} , where {Y}_{n}^{( k )} = {[ {[ {x}_{LDC}^{( k , 1 )} ]}_{n , 1} , … , {[ {x}_{LDC}^{( k , T )} ]}_{n , 1} ]}^{T}$$

and k=1,2. M is the channel symbol matrix corresponding to the block C, M=diag(M⁽¹⁾,M⁽²⁾), where M⁽¹⁾ and M⁽²⁾ are the matrices corresponding to the LDC codeword

$${S}_{LDC}^{CI ( 1 )} and {S}_{LDC}^{CI ( 2 )} ,$$

respectively, M^{(k)}=I_{N}_{_{R}}⊕diag[M₁^{(k)}, . . . ,M_{N}_{_{T}}^{(k)}],

$${M}_{m}^{( k )} = diag ( {[ {S}_{LDC}^{( k )} ]}_{1 , m} , … , {[ {S}_{LDC}^{( k )} ]}_{T , m} ) , k = 1 , 2.$$

the channel vector H=[[H⁽¹⁾]^{T},[H⁽²⁾]^{T}]^{T}, where

$${H}^{( k )} = {[ {h}_{( k ) 1 , 1}^{T} , … , {h}_{( k ) 1 , {N}_{T}}^{T} , … , {h}_{( k ) {N}_{R} , 1}^{T} , … , {h}_{( k ) {N}_{R} , {N}_{T}}^{T} ]}^{T}$$

$$and$$

$${h}_{( k ) n , m} = {[ {h}_{n , m}^{( k , 1 )} , … , {h}_{n , m}^{( k , T )} ]}^{T} .$$

A directional pair, denoted as X→Y, means that a system detects X as Y. Consider the direction pair of matrices M and \tilde{M} corresponding to two different ST-LDC blocks C and \tilde{C}. The upper bound pairwise error probability [11] is

$$P ( M -> \tilde{M} ) \leq ( \begin{matrix}2 r - 1 \\ r\end{matrix} ) {( {\prod }_{a = 1}^{r} {γ}_{a} )}^{- 1} {( \frac{ρ}{{N}_{T}} )}^{- r} \qquad ( 6 )$$

where r is the rank of (M−\tilde{M})R_{H}_{⁽ⁱ⁾}(M−\tilde{M})^{H} and R_{H}=E{H[H]^{H}} of size 2N_{T}N_{R}T×2N_{T}N_{R}T is correlation matrix of H, γₐ,a=1, . . . ,r of are the non-zero eigenvalues of Λ=(M−\tilde{M})R_{H}(M−\tilde{M})^{H}.
Then the rank and product criteria are:
1) Rank criterion: The minimum rank of Λ over all direction pairs of different matrices M and \tilde{M} should be as large as possible.
2) Product criterion: the minimum value of the product

$${\prod }_{a = 1}^{r} {γ}_{a}$$

over all pairs of different M and \tilde{M} should be maximized.

To maximize the rank of Λ, the ranks of both R_{H} and (M−\tilde{M}) are to be maximized. Denote Ω^{(k)}=M^{(k)}−\tilde{M}^{(k)}, where k=1,2.

Assume that all the possible M^{(k)} and \tilde{M}^{(k)} are contained in a set {M^{(k)},\tilde{M}(k)}ε [symbol] ^{(k)}, where k=1,2.

Then the diversity order of the ST-CILDC, r_{d}, is
r_{d}=min {rank(Λ),Mε,\tilde{M}ε,M≠\tilde{M}} (7)
When M≠\tilde{M}, there are three categories of different situations,
M⁽¹⁾≠\tilde{M}⁽¹⁾ and M⁽²⁾=\tilde{M}⁽²⁾ 1)
M⁽¹⁾=\tilde{M}⁽¹⁾ and M⁽²⁾≠\tilde{M}⁽²⁾ 2)
M⁽¹⁾≠\tilde{M}⁽¹⁾ and M⁽²⁾≠\tilde{M}⁽²⁾ 3)
Note that when R_{H} is full rank,
1) in the above Situations (1) and (2), the upper bound of rank(Λ) is N_{R}T,
2) in the above Situation (3), the upper bound of rank(Λ) is 2N_{R}T,
Thus ST-CILDC does not further increase the diversity order over ST-LDC in terms of the conventional definition (6). However, ST-CILDC does increase r over ST-LDC for the above-mentioned third situation, which is not the conventional diversity order of the STC and may significantly impact system performance. It is necessary to introduce a new concept to quantify this effect as follows,
Definition 1

Statistical diversity order, r_{std}, is the rank of Λ achieved with a certain probability α, mathematically written as

$$Pr \{ \begin{matrix}rank ( Λ ) \geq {r}_{std} , \\ M \neq \tilde{M} , \\ \{ M , \tilde{M} \} ∈ ℳ ,\end{matrix} \} = α \qquad ( 8 )$$

Then, we have the following theorem.
Theorem 1
A ST-CILDC is constructed through coordinate interleaving across a pair of component LDC codewords. Both component LDC encoders are able to generate different codewords for different input sequences. The diversity orders of the component LDCs are r_{d}⁽¹⁾ and r_{d}⁽²⁾, respectively. Suppose that R_{H} is full rank. The codebook sizes of the two component LDCs are the same value, Nₐ.
1) The diversity order of this ST-CILDC, r_{d}, is

$$min \{ {r}_{d}^{( 1 )} , {r}_{d}^{( 2 )} \} .$$

2) Assuming that all directional pairs M and M are equally probable, the statistical diversity order of this ST-CILDC, r_{sd}, is (r_{d}⁽¹⁾+r_{d}⁽²⁾) with probability

$$α = \frac{( \begin{matrix}{N}_{a} \\ 2\end{matrix} ) ( \begin{matrix}{N}_{a} \\ 2\end{matrix} )}{( \begin{matrix}{N}_{a} \\ 2\end{matrix} ) ( \begin{matrix}{N}_{a} \\ 2\end{matrix} ) + {N}_{a} ( \begin{matrix}{N}_{a} \\ 2\end{matrix} )}$$

A problem of the above discussion is that the analysis is purely based on pairwise error probability. However, system performance is normally expressed as average error probability (AEP). A diversity concept is introduced based on AEP.

Definition 2

Denote AEP of the communications system with the codeword block set {M} at average receive SNR ρ as AEP{M,ρ}. Assume that AEP{M,ρ} is differentiable at ρ.

Denote
f(ρ)=log₁₀AEP{M,ρ}
and
g(ρ)=log₁₀ρ
The average diversity order, r_{ad}, at the average signal-to-noise ratio (SNR) of each receive antenna, ρ, is defined as a differential

$${r}_{ad} = - \frac{\partial f ( ρ )}{\partial g ( ρ )} \qquad ( 9 )$$

Note that AEP cannot be generally derived. Thus, an analysis of the diversity performance of CI-STLDC based on the error union bound is provided. EUB, an upper bound on the average error probability, is an average of the pairwise error probabilities between all direction pairs of codewords. The EUB based analysis is not provided in detail. The result of this analysis is that the average diversity order of CI-STLDC can be approximated as either

$$min \{ {r}_{d}^{( 1 )} , {r}_{d}^{( 2 )} \} or ( {r}_{d}^{( 1 )} + {r}_{d}^{( 2 )} ) ,$$

the choice of which depends on the value of SNR ρ and the codebook size Nₐ. In the case of

$${r}_{ad} = min \{ {r}_{d}^{( 1 )} , {r}_{d}^{( 2 )} \} ,$$

the merit of CI appears as an extra coding advantage.

Note that except for the trivial extra computational load of coordinate interleaving, for the same size of LDC encoding matrices, the complexity per LDC codeword of the ST-CILDC system is almost the same as that of conventional LDC systems. However, the upper bound achievable average diversity order of a ST-CILDC system is almost twice that of conventional block-based space-time code (BSTC) systems if the two component LDCs in the ST-CILDC have similar diversity features. It is worth mentioning that using nonlinear sphere or ML decoding, the conventional BSTC systems need much higher complexity to reach an average diversity order comparable to ST-CILDC.

It is noted that the scope of this approach is not limited to LDC. Other block-based space-time code designs may also be improved using the proposed space-time inter-LDC coordinate interleaving approach. Further, the pair of LDC codewords used in ST-CILDC could be viewed as a single specially designed LDC codeword of size 2T×N_{T}. Thus ST-CILDC systems could be viewed as extensions of LDC systems using different design criteria.

Performance

A. Simulation Setup

Perfect channel knowledge (amplitude and phase) is assumed at the receiver but not at the transmitter. Assume the number of receive antennas is equal to the number of transmit antennas. Channel symbols are estimated using MMSE estimation. Data symbols use QPSK modulation in all simulations. The signal-to-noise-ratio (SNR) reported in all figures is the average symbol SNR per receive antenna. The matrix channel is assumed to be constant over different integer numbers of channel uses or symbol time slots, and i.i.d. between blocks. We denote this interval as the channel change interval (CCI).

Three space-time block codes, Code A, Code B, and Code C, are used as component LDC coding matrices of ST-CILDC systems in the simulations. Code A is chosen from Eq. (31) of [4], a class of rate-one square LDC of arbitrary size proposed by Hassibi and Hochwald. Code B is chosen from Design A of full diversity full rate (FDFR) codes proposed by Ma and Giannakis [12]. Code C is a non-rate-one high rate code for the configuration of N_{T}=4,T=6,Q=12, proposed by Hassibi and Hochwald [4].

B. Performance Comparison

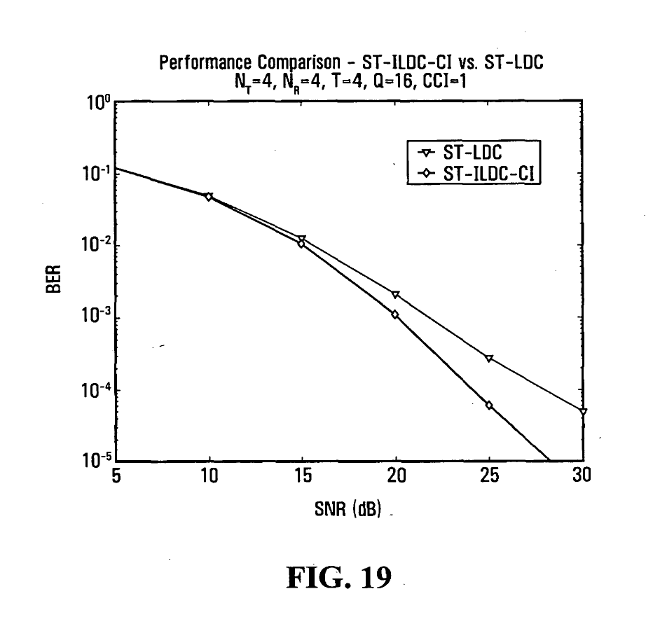

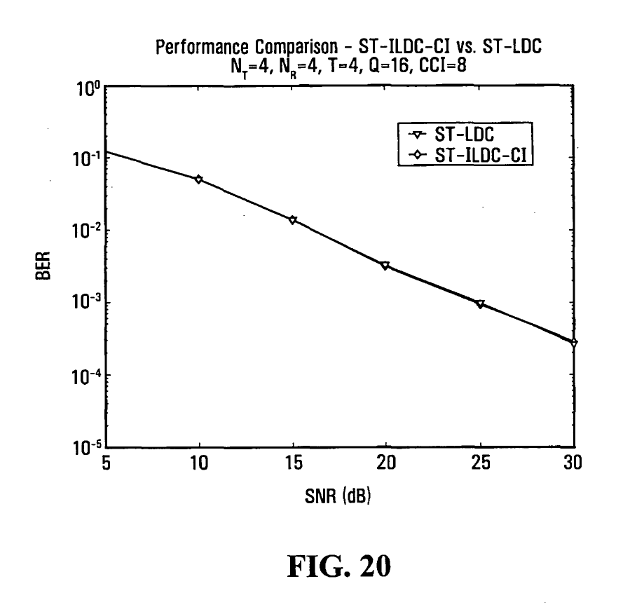

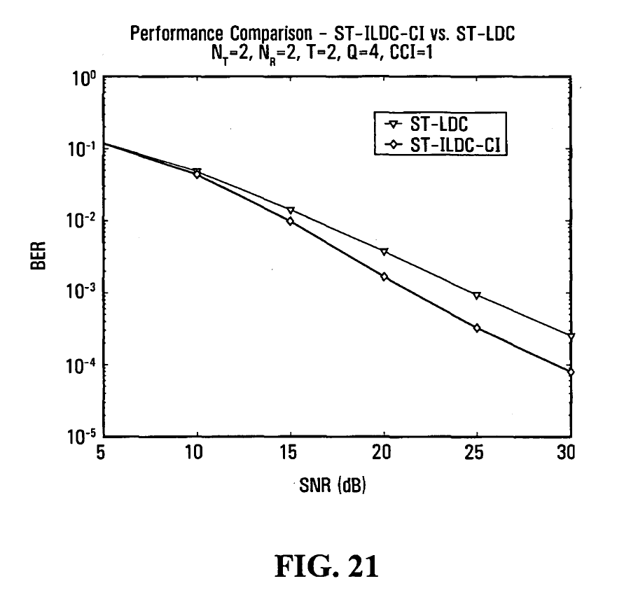

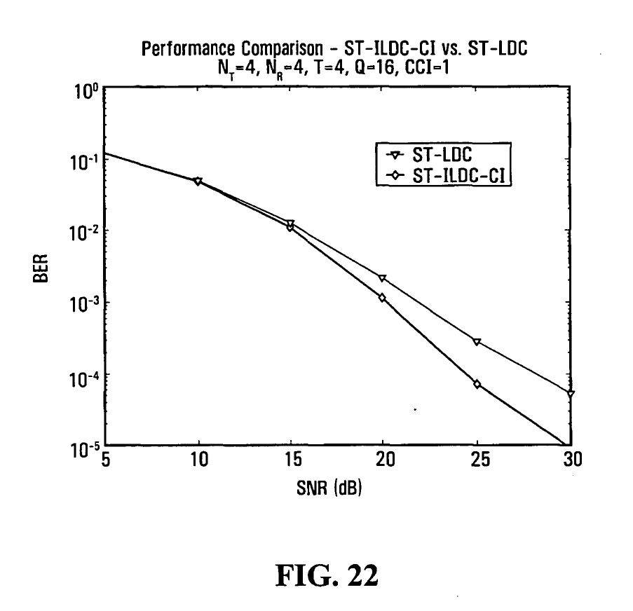

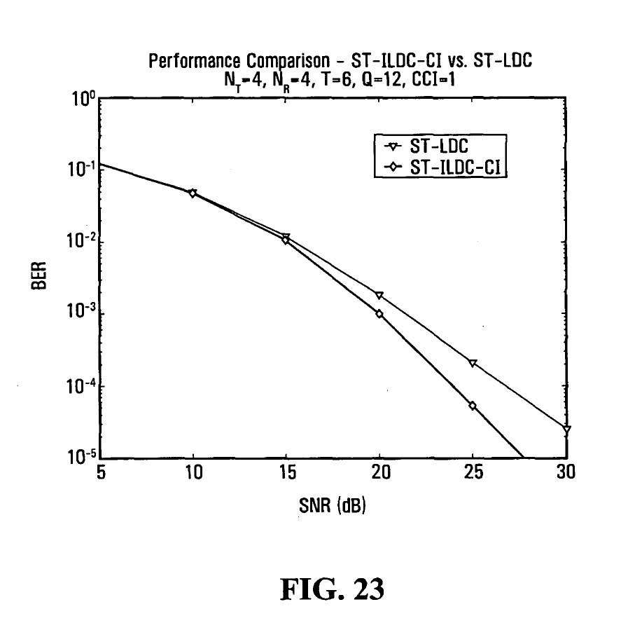

The performance comparison of code A is shown in FIGS. 19, 20 and 21. The performance comparison of code B is shown in FIG. 22. The performance comparison of code C is shown in FIG. 23. In block fading channels, i.e., when the 4×4 MIMO channels are constant over the pair of ST-LDC codewords and code A is used, ST-CILDC obtains the same performance as that of ST-LDC as shown in FIG. 20. However, as shown in FIGS. 19, 21, 22, and 23, ST-CILDC significantly outperforms ST-LDC at high SNRs in rapid fading channels. Thus, the ST-CILDC procedure may be applied to both rate-one and slightly lower rate codes. Observing FIGS. 19 and 22, the performances of code A and code B are similar in rapid fading channels. Thus, even though code A is not designed under a diversity criterion, code A appears to possess good diversity properties.

The following references are provided in respect of the above section:

[1] V. Tarokh, N. Seshadri, and A. Calderbank, “Space-time codes for high data rate wireless communications: performance criterion and code construction,” IEEE Trans. Inform. Theory, vol. 44, pp. 744-765, March 1998.
[2] S. Alamouti, “A simple transmitter diversity scheme for wireless communications,” IEEE J. Select. Areas Commun., pp. 1451-1458, October 1998.
[3] V. Tarokh, H. Jafarkhani, and A. R. Calderbank, “Space-time block code from orthogonal designs 3,” IEEE Trans. Inform. Theory, vol. 45, pp. 1456-1467, July 1999.
[4] B. Hassibi and B. M. Hochwald, “High-rate codes that are linear in space and time,” IEEE Trans. Inform. Theory, vol. 48, no. 7, pp. 1804-1824, July 2002.
[5] K. Boulle and J. C. Belfiore, “Modulation schemes designed for the Rayleigh channel,” in Proc. CISS 1992, 1992, pp. 288-293.
[6] B. D. Jelicic and S. Roy, “Cutoff rates for coordinate interleaved QAM over Rayleigh fading channels,” IEEE Trans. Commun., vol. 44, no. 10, pp. 1231-1233, October 1996.
[7] Y.-H. Kim and M. Kaveh, “Coordinate-interleaved space-time coding with rotated constellation,” in Proc. IEEE VTC, vol. 1, April 2003, pp. 732-735.
[8] M. Z. A. Khan and B. S. Rajan, “Space-time block codes from co-ordinate interleaved orthogonal designs,” in Proc. IEEE ISIT 2002, 2002, pp. 275-275.
[9] M. Z. A. Khan, B. S. Rajan, and M. H. Lee, “Rectangular co-ordinate interleaved orthogonal designs,” in Proc. IEEE Globecom 2003, vol. 4, December 2003, pp. 2003-2009.
[10] W. Su, Z. Safar, and K. J. R. Liu, “Diversity analysis of space-time modulation over time-correlated Rayleigh-fading channels,” IEEE Trans. Inform. Theory, vol. 50, no. 8, pp. 1832-1840, August 2004.
[11] S. Siwamogsatham, M. P. Fitz, and J. H. Grimm, “A new view of performance analysis of transmit diversity schemes in correlated Rayleigh fading,” IEEE Trans. Inform. Theory, vol. 48, no. 4, pp. 950-956, April 2002.
[12] X. Ma and G. B. Giannakis, “Full-diversity full-rate complex-field spacetime coding,” IEEE Trans. on Sig. Proc., vol. 51, no. 11, pp. 2917-2930, November 2003.
   Coordinate Interleaving Based STFC
   Relation to STFC Designs

Coordinate Interleaving (CI) STFC is a low complexity design method of STFC, which can be applied to arbitrary rate complex diversity coding (CDC) based STFC, such as LD-STFC and DLD-STFC. The common point is to establish on linear dispersion codes based high rate STFC. Note that CDC based frequency-time codes, space-time codes, and space-frequency codes are subsets of STFC. Thus CI based FTC, SFC, and STC are subsets of CI based STFCs.

### INTRODUCTION

A problem in most existing design criteria of block-based space-time codes, including LDC (which allow different dispersion matrices for real and image parts of coordinates), is that they do not efficiently exploit additional diversity potential in the real and image parts of coordinates of source data constellation symbols. A technique to utilize the diversity potential of real and image parts of coordinates is called coordinate interleaving or component interleaving (CI), which was first proposed for single transmission stream system [5] [6]. Recently, CI has been applied to multiple antennas systems [7] [8] [9]. Kim and Kaveh have combined CI-OSTBC and constellation rotation [7]. Khan, Rajan, and Lee used CI concepts to design coordinate space-time orthogonal block codes [8] [9]. However, current existing approaches to using CI in block-based space-time codes are low-rate designs using orthogonal space-time block codes or their variation [7] [8] [9].

This section provides coordinate-interleaving as a general principle for high-rate block-based space-time-frequency code design, i.e., linear dispersion coordinate interleaved space-time-frequency codes (LD-CI-STFC). LD-CI-STFC maintains the same diversity order as conventional LD-STFC. However, LD-CI-STFC may show either almost doubled average diversity order or extra coding advantage over conventional LD-STFC in time varying channels. Compared with conventional LD-STFC, LD-CI-STFC maintains the diversity performance in quasi-static block fading channels, and notably improves the diversity performance in rapid fading channels. LD-CI-STFC may be applied to either wireless STFC systems or wireline STFC systems.

System Model

A MIMO-OFDM system (which can be either wireline or wireless system) with N_{T} transmit and N_{R} receive channels and N_{C} subcarriers is considered. In frequency-selective, time non-selective Rayleigh fading channels over one OFDM block whose coefficients may vary per OFDM block or channel use. Assume that an uncorrelated data sequence has been modulated using complex-valued source data symbols chosen from an arbitrary, e.g. ND-PSK or ND-QAM, constellation. Each LD-STFC codeword of size T×N_{L}×N_{K} is transmitted during every T time channel uses from N_{L} transmit channels and N_{K} subcarriers, where N_{L}≦N_{T} and N_{K}≦N_{C}.

Procedure of Inter-LD-STFC Coordinate Interleaving

There are a pair of source data symbol vectors s₁ and s₂ with the same number Q of source data symbol symbols, where

$${s}^{( 1 )} = {[ {s}_{1}^{( 1 )} , … , {s}_{Q}^{( 1 )} ]}^{T} , \\ {s}^{( 1 )} = {[ {s}_{1}^{( 2 )} , … , {s}_{Q}^{( 2 )} ]}^{T}$$

$$and$$

$${s}_{q}^{( i )} = Re ( {s}_{q}^{( i )} ) + jIm ( {s}_{q}^{( i )} ) ,$$

where i=1,2,q=1, . . . ,Q. The transmitter first coordinate-interleaves s⁽¹⁾ and s⁽²⁾ into s^{CI(1)} and s^{CI(2)}, where

$${s}^{CI ( 1 )} = {[ {s}_{1}^{CI ( 1 )} , … , {s}_{Q}^{CI ( 1 )} ]}^{T} , \\ {s}^{CI ( 2 )} = {[ {s}_{1}^{CI ( 2 )} , … , {s}_{Q}^{CI ( 2 )} ]}^{T} , \\ {s}_{q}^{CI ( 1 )} = Re ( {s}_{q}^{( 1 )} ) + jIm ( {s}_{q}^{( 2 )} ) , \\ {s}_{q}^{CI ( 2 )} = Re ( {s}_{q}^{( 2 )} ) + jIm ( {s}_{q}^{( 1 )} ) ,$$

then encodes s^{CI(1)} and s^{CI(2)} into two LD-STFC (or DLD-STFC) codewords of size T×N_{T}

$${S}_{LDC}^{CI ( 1 )} and {S}_{LDC}^{CI ( 2 )} ,$$

respectively. encoded into two LD-STFC (or DLD-STFC) codewords of size T×N_{L}×N_{K},

$${S}_{LD - STFC}^{CI ( 1 )} and {S}_{LD - STFC}^{CI ( 2 )} ,$$

respectively. Then the transmitter send

$${S}_{LD \text{-} STFC}^{CI ( 1 )} and {S}_{LD \text{-} STFC}^{CI ( 2 )}$$

during such two interleaved dimensions (either space or time or frequency). CI for LD-STFC may be with three different ways.
1. Space CI: in this case,

$${N}_{L} \leq \frac{1}{2} {N}_{T}$$

and two LD-STFC codewords are parallel in space,
2. Time CI: in this case, two LD-STFC codewords are transmitted successively in time,
3. Frequency CI: in this case,

$${N}_{K} \leq \frac{1}{2} {N}_{C}$$

and two LD-STFC codewords are parallel in frequency.
It is noted that
1. using different permutations, other methods of space-time inter-LDC CI are also possible;
2. The encoding matrices for

$${S}_{LD \text{-} STFC}^{CI ( 1 )} and {S}_{LD \text{-} STFC}^{CI ( 2 )}$$

may not necessarily be the same.

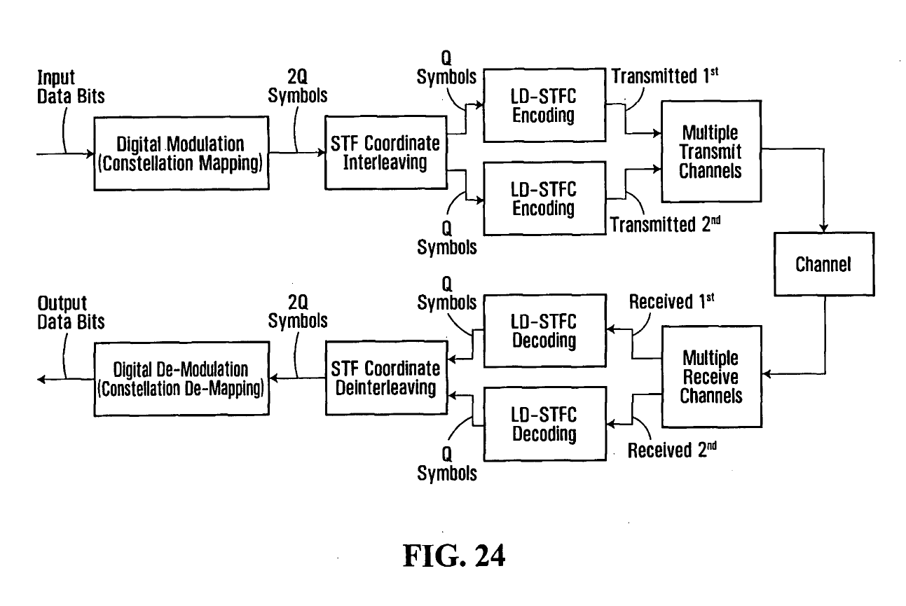

An example of the LD-CI-STFC system structure is shown in FIG. 24. The system structure basically consists of three layers: (1) mapping from data bits to constellation points, (2) inter-LD-STFC coordinate interleaving, and (3) LD-STFC (or DLD-STFC) coding.

Using the provided layered structure, the only additional complexity compared with a conventional LD-STFC system is the coordinate interleaving operation. Thus, the LD-CI-STFC system is computationally efficient. The motivation of LD-CI-STFC is to render the fading more independent of each coordinate of the source data signals. Compared with LD-STFC (or DLD-STFC) systems, the result of using LD-CI-STFC is to introduce coordinate fading diversity (at the cost of more decoding delay if using Time CI).

We also have the following extensions:

1. We may extend LD-CI-STFC to non-linear complex coding (approaches, NLD-CI-STFC, in which CI performs between two non-linear dispersion STFCs. The so-called non-linear dispersion codes (NLDC) transform complex input symbols into a matrix or 3-dimensional array through non-linear transformation.
2. We may perform CI operation between two multiple dimension linear or non-linear complex codes (the number of dimensions is larger than 3).
   The following references are provided in respect of the above section:
[1] V. Tarokh, N. Seshadri, and A. Calderbank, “Space-time codes for high data rate wireless communications: performance criterion and code construction,” IEEE Trans. Inform. Theory, vol. 44, pp. 744-765, March 1998.
[2] S. Alamouti, “A simple transmitter diversity scheme for wireless communications,” IEEE J. Select. Areas Commun., pp. 1451-1458, October 1998.
[3] V. Tarokh, H. Jafarkhani, and A. R. Calderbank, “Space-time block code from orthogonal designs 3,” IEEE Trans. Inform. Theory, vol. 45, pp. 1456-1467, July 1999.
[4] B. Hassibi and B. M. Hochwald, “High-rate codes that are linear in space and time,” IEEE Trans. Inform. Theory, vol. 48, no. 7, pp. 1804-1824, July 2002.
[5] K. Boulle and J. C. Belfiore, “Modulation schemes designed for the Rayleigh channel,” in Proc. CISS 1992, 1992, pp. 288-293.
[6] B. D. Jelicic and S. Roy, “Cutoff rates for coordinate interleaved QAM over Rayleigh fading channels,” IEEE Trans. Commun., vol. 44, no. 10, pp. 1231-1233, October 1996.
[7] Y.-H. Kim and M. Kaveh, “Coordinate-interleaved space-time coding with rotated constellation,” in Proc. IEEE VTC, vol. 1, April 2003, pp. 732-735.
[8] M. Z. A. Khan and B. S. Rajan, “Space-time block codes from co-ordinate interleaved orthogonal designs,” in Proc. IEEE ISIT 2002, 2002, pp. 275-275.
[9] M. Z. A. Khan, B. S. Rajan, and M. H. Lee, “Rectangular co-ordinate interleaved orthogonal designs,” in Proc. IEEE Globecom 2003, vol. 4, December 2003, pp. 2003-2009.
[10] W. Su, Z. Safar, and K. J. R. Liu, “Diversity analysis of space-time modulation over time-correlated Rayleigh-fading channels,” IEEE Trans. Inform. Theory, vol. 50, no. 8, pp. 1832-1840, August 2004.
[11] S. Siwamogsatham, M. P. Fitz, and J. H. Grimm, “A new view of performance analysis of transmit diversity schemes in correlated Rayleigh fading,” IEEE Trans. Inform. Theory, vol. 48, no. 4, pp. 950-956, April 2002.
[12] X. Ma and G. B. Giannakis, “Full-diversity full-rate complex-field spacetime coding,” IEEE Trans. on Sig. Proc., vol. 51, no. 11, pp. 2917-2930, November 2003.

We claim:

1. A method comprising:
performing two vector→matrix encoding operations in sequence to produce a three dimensional result containing a respective symbol for each of a plurality of frequencies, for each of a plurality of transmit durations, and for each of a plurality of transmitter outputs.

2. The method of claim 1 wherein the two vector→matrix encoding operations are for encoding in a) time-space dimensions and b) time-frequency dimensions sequentially or vice versa.

3. The method of claim 1 wherein the two vector→matrix encoding operations are for encoding in a) time-space dimensions and b) space-frequency dimensions sequentially or vice versa.

4. The method of claim 1 wherein the two vector→matrix encoding operations are for encoding in a) space-frequency dimensions, and b) space-time dimensions sequentially or vice versa.

5. The method of claim 1 wherein the two vector→matrix encoding operations are for encoding in a) space-frequency, and b) frequency-time dimensions sequentially or vice versa.

6. The method of claim 1 wherein the plurality of frequencies comprise a set of OFDM sub-carrier frequencies.

7. The method of claim 1 further comprising:
defining a plurality of subsets of an overall set of OFDM sub-carriers;
executing said performing for each subset to produce a respective three dimensional result.

8. The method of claim 7 wherein executing comprises:
for each subset of the plurality of subsets of OFDM sub-carriers,
a) for each of a plurality of antennas, encoding a respective set of input symbols into a respective first matrix with frequency and time dimensions using a respective first vector→matrix code, each first matrix having components relating to each of the sub-carriers in the subset;
b) for each sub-carrier of the subset, encoding a set of input symbols consisting of the components in the first matrices relating to the sub-carrier into a respective second matrix with space and time dimensions using a second vector→matrix code;
c) transmitting each second matrix on the sub-carrier with rows and columns of the second matrix mapping to space (antennas) and time (transmit durations) or vice versa.

9. The method of claim 1 wherein at least one of the first vector→matrix code and second vector→matrix code is a linear dispersion code.

10. The method of claim 1 wherein the first vector→matrix code and the second vector→matrix code are linear dispersion codes.

11. The method claim 8 wherein, in each first matrix, the components relating to each of the sub-carriers in the subset comprise a respective column or row of the first matrix.

12. The method of claim 1 wherein both the first vector→matrix code has a symbol coding rate ≧0.5 and the second vector→matrix code has a symbol coding rate ≧0.5.

13. The method of claim 1 wherein both the first vector→matrix code has a symbol coding rate of one and the second vector→matrix code has a symbol coding rate of one.

14. The method of claim 1 in which there are M×N×T dimensions in space, frequency, and time and wherein the first and second vector→matrix codes are selected such that an overall symbol coding rate R is larger than
$$\frac{1}{min \{ M , N , T \}} .$$

15. The method of claim 1 wherein the vector→matrix encoding operations are selected such that outputs of each encoding operation are uncorrelated with each other assuming uncorrelated inputs.

16. The method of claim 7 comprising:
for each of the plurality of subsets of an overall set of OFDM sub-carriers,
a) for each sub-carrier of the subset of sub-carriers, encoding a respective set of input symbols into a respective first matrix with space and time dimensions using a respective first vector→matrix code, each first matrix having components relating to each of a plurality of antennas;
b) for each of the plurality of antennas, encoding a respective set of input symbols consisting of the components in the first matrices relating to the antenna into a respective second matrix with frequency and time dimensions using a second vector→matrix code;
c) transmitting each second matrix on the antenna with rows and columns of the matrix mapping to frequency (sub-carriers) and time (transmit durations) or vice versa.

17. A method comprising:
defining a plurality of subsets of an overall set of OFDM sub-carriers;
for each subset of the plurality of subsets of OFDM sub-carriers:
performing a linear dispersion encoding operation upon a plurality of input symbols to produce a two dimensional matrix output;
partitioning the two dimensional matrix into a plurality of matrices, the plurality of matrices consisting of a respective matrix for each of a plurality of transmit antennas;
transmitting each matrix on the respective antenna by mapping rows and columns to sub-carrier frequencies and transmit symbol durations or vice versa.

18. A method comprising:
performing a linear dispersion encoding operation upon a plurality of input symbols to produce a two dimensional matrix output;
partitioning the two dimensional matrix into a plurality of two dimensional matrix partitions;
transmitting the partitions by executing one of:
transmitting each matrix partition during a respective transmit duration in which case the matrix partition maps to multiple frequencies and multiple transmitter outputs; and
transmitting each matrix partition on a respective frequency in which case the matrix partition maps to multiple transmit durations and multiple transmitter outputs;
transmitting each matrix partition on a respective transmitter output in which case the matrix partition maps to multiple frequencies and multiple transmit durations.

19. The method of claim 1 further comprising transmitting each transmitter output on a respective antenna.

20. The method of claim 1 wherein the codes are selected to have full diversity under the condition of single symbol errors in the channel.

21. The method of claim 1 wherein the codes are selected such that method achieves all an capacity available in an STF channel.

22. The method of claim 7 wherein the subsets of OFDM sub-carriers have variable size.

23. A transmitter adapted to implement the method of claim 1.

24. The transmitter of claim 23 comprising:
a plurality of transmit antennas;
at least one vector→matrix encoder adapted to execute vector→matrix encoding operations;
a multi-carrier modulator for producing outputs on multiple frequencies.

25. The transmitter of claim 20 wherein the multi-carrier modulator comprises an IFFT function.

26. A method comprising:
receiving a three dimensional signal containing a respective symbol for each of a plurality of frequencies, for each of a plurality of transmit durations, and for each of a plurality of transmitter outputs;
performing two matrix→vector decoding operations in sequence to recover a set of transmitted symbols.

27. The method of claim 26 wherein at least one of the matrix→vector decoding operations is an LDC decoding operation.

28. The method of claim 26 wherein the two matrix→vector decoding operations are LDC decoding operations.

29. The method of claim 26 wherein the two vector→matrix encoding operations are for encoding in a) time-space dimensions and b) time-frequency dimensions sequentially or vice versa.

30. The method of claim 26 wherein the two vector→matrix decoding operations are for decoding in a) time-space dimensions and b) space-frequency dimensions sequentially or vice versa.

31. The method of claim 26 wherein the two vector→matrix decoding operations are for decoding in a) space-frequency dimensions, and b) space-time dimensions sequentially or vice versa.

32. The method of claim 26 wherein the two vector→matrix decoding operations are for decoding in a) space-frequency, and b) frequency-time dimensions sequentially or vice versa.

33. The method of claim 26 wherein the three dimensional signal consists of a OFDM signals transmitted on a set of transmit antennas.

34. The method of claim 26 executed once for each of a plurality of subsets of OFDM sub-carriers.

35. A receiver adapted to implement the method of claim 26.

36. A method according to claim 1 in which LD codes are employed that have block sizes other than a) square and b) having a column size that is a multiple of the row size.
